(19) United States
(12) Patent Application Publication
(10) Pub. No.: US 2020/0290513 A1
(43) Pub. Date: Sep. 17, 2020

(54) LIGHT FIELD DISPLAY SYSTEM FOR VEHICLE AUGMENTATION

(71) Applicant: Light Field Lab, Inc., San Jose, CA (US)

(72) Inventors: Jonathan Sean Karafin, Morgan Hill, CA (US); Brendan Elwood Bevensee, San Jose, CA (US); John Dohm, Beverly Hills, CA (US)

(21) Appl. No.: 16/352,695

(22) Filed: Mar. 13, 2019

(51) Int. Cl. B60R 1/00; G06F 3/01; G06F 3/14; G02B 27/01; G03H 1/02; G03H 1/00; F41H 3/00

(52) U.S. Cl. CPC B60R 1/00; B60R 2300/30; G06F 3/016; G06F 3/013; G06F 3/011; G06F 3/1446; G02B 27/0103; G02B 27/0179; G03H 1/0248; G03H 1/0005; F41H 3/00; G02B 2027/0187; G02B 2027/0141; G02B 2027/0138; G03H 2001/0216; G03H 2223/16; G03H 2223/24; G03H 2210/32; G03H 2210/50; G06F 3/017

(57) ABSTRACT

A light field (LF) display system for augmentation of a vehicle. The LF display system includes LF display modules that form a surface (e.g., interior and/or exterior) of a vehicle. The LF display modules each have a display area and are tiled together to form a seamless display surface that has an effective display area that is larger than the display area. The LF display modules present holographic content from the effective display area.

### CROSS REFERENCE TO RELATED APPLICATIONS

This application is related to International Application Nos. PCT/US2017/042275, PCT/US2017/042276, PCT/US2017/042418, PCT/US2017/042452, PCT/US2017/042462, PCT/US2017/042466, PCT/US2017/042467, PCT/US2017/042468, PCT/US2017/042469, PCT/US2017/042470, and PCT/US2017/042679, all of which are incorporated by reference herein in their entirety.

### BACKGROUND

The present disclosure relates vehicles, and specifically relates to light field display systems for vehicle augmentation.

Conventional vehicles (e.g., personal transport, commercial transport, government transport, etc.) are manufactured to have a particular appearance, both in the interior and the exterior. Additionally, this appearance is fixed and is not easily changed. For example, a car owner would have to re-paint their car to change its color. Likewise, interior layout of controls and interior cabin space are also fixed. For example, the locations of the instrument panel, steering wheel, shifter, window controls, door locks, etc., are fixed in place and have a specific appearance. As an appearance of a vehicle is fixed during manufacture and can be difficult to change after manufacture, vehicle manufactures generally offer various options (paint color, trim color, etc.) by which consumers can elect. But offering options in this manner not only is expensive for vehicle manufactures, but also at most offers limited customization of the vehicle to the user.

### SUMMARY

A light field (LF) display system for augmentation of a vehicle (e.g., automobile, plane, etc.). The LF display system includes a LF display assembly that includes at least one LF display module that form a surface (e.g., interior, exterior, etc.) of the vehicle. The at least one LF display module is configured to present one or more holographic objects (e.g., door control interface, instrument cluster, pinstripe, etc.) at a plurality of locations relative to a display surface of the at least one LF display module. The locations include locations between the display surface and a viewing volume of the at least one display surface.

In some embodiments, the holographic content may include holographic objects that a user interacts with in order to provide instructions to the vehicle. For example, in some embodiments, the LF display includes a plurality of ultrasonic speakers (e.g., as part of the LF display modules) and a tracking system. The plurality of ultrasonic speakers are configured to generate a haptic surface that coincides with at least a portion of the holographic object. The tracking system is configured to track an interaction of a user with the holographic object (e.g., via images captured by imaging sensors of the LF display modules and/or some other cameras). And the LF display system is configured to provide an instruction to the vehicle based on the interaction.

In some embodiments, a LF display system includes at least one LF display module that is mounted on an exterior surface of a vehicle. The at least one LF display module projects holographic objects at a plurality of configurable physical locations relative to a display surface of the at least one LF display module. The locations include locations between the display surface and a viewing volume of the at least one display surface, and the holographic objects change an external appearance of the vehicle.

### BRIEF DESCRIPTION OF THE DRAWINGS

FIG. 1 is a diagram of a light field display module presenting a holographic object, in accordance with one or more embodiments.

FIG. 2A is a cross section of a portion of a light field display module, in accordance with one or more embodiments.

FIG. 2B is a cross section of a portion of a light field display module, in accordance with one or more embodiments.

FIG. 3A is a perspective view of a light field display module, in accordance with one or more embodiments.

FIG. 3B is a cross-sectional view of a light field display module which includes interleaved energy relay devices, in accordance with one or more embodiments.

FIG. 4A is a perspective view of portion of a light field display system that is tiled in two dimensions to form a single-sided seamless surface environment, in accordance with one or more embodiments.

FIG. 4B is a perspective view of a portion of light field display system in a multi-sided seamless surface environment, in accordance with one or more embodiments.

FIG. 5 is a block diagram of a light field display system, in accordance with one or more embodiments.

FIG. 6A is a perspective view of a vehicle augmented with a light field display system, in accordance with one or more embodiments.

FIG. 6B is a perspective view of the vehicle of FIG. 6A presenting holographic content, in accordance with one or more embodiments.

FIG. 7A is a perspective view of an interior of a vehicle augmented with a light field display system, in accordance with one or more embodiments.

FIG. 7B is a perspective view of the interior of FIG. 7A presenting holographic content, in accordance with one or more embodiments.

FIG. 8 is a perspective view of the interior of a vehicle augmented with a light field display system including augmented windows, in accordance with one or more embodiments.

FIG. 9 is a perspective view of an interior of a vehicle augmented with a light field display system including an augmented sunroof, in accordance with one or more embodiments.

FIG. 10 is a perspective view of a vehicle augmented with a light field display system to mitigate blind spots, in accordance with one or more embodiments.

FIG. 11 illustrates an example system that relays holographic objects projected by a light field display using a transmissive reflector, in accordance with one or more embodiments.

FIG. 12 illustrates overlap of occupant fields of view within a vehicle, in accordance with one or more embodiments.

FIG. 13A shows an example view of a light field display with a substantially uniform projection direction, in accordance with one or more embodiments.

FIG. 13B shows an example view of a light field display with a variable projection direction, in accordance with one or more embodiments.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview

A light field (LF) display system is implemented in a vehicle. The LF display system may form a multi-sided seamless surface environment over some or all of one or more surfaces (interior and/or exterior) of a vehicle. The LF display system can present holographic content to users of the vehicle, and in some embodiments, users external to the vehicle. A user is generally a viewer of the holographic content, and may also be a driver, a passenger (a person inside the vehicle and is not the driver), an occupant (a person inside the vehicle), or a person external to the vehicle. The LF display system comprises a LF display assembly configured to present holographic content including one or more holographic objects that would be visible to one or more users in a viewing volume of the LF display system. A holographic object may also be augmented with other sensory stimuli (e.g., tactile and/or audio). For example, ultrasonic emitters in the LF display system may emit ultrasonic pressure waves that provide a tactile surface for some or all of the holographic object. Holographic content may include additional visual content (i.e., 2D or 3D visual content). The coordination of emitters to ensure that a cohesive experience is enabled is part of the system in multi-emitter implementations (i.e., holographic objects providing the correct haptic feel and sensory stimuli at any given point in time.) The LF display assembly may include one or more LF display modules for generating the holographic content.

In some embodiments, the LF display system includes a plurality of LF display modules that are part of an exterior surface of a vehicle. The LF display modules along the exterior surface may be configured to project holographic content to change an appearance of the vehicle. In this manner, a user of LF display system can modify how the vehicle appears to viewers outside of the vehicle. For example, the LF display system may change a color of some or all of the vehicle, shape of some or all of the vehicle, or some combination thereof. The LF display system may change the shape of the vehicle using holographic objects (e.g., a spoiler, hood scoop, etc.) presented by some or all of the LF display modules along the exterior surface of the vehicle.

In some embodiments, the LF display system includes a plurality of LF display modules that are part of an interior surface of a vehicle. The LF display modules along the interior surface may be configured to project holographic content to change an appearance of the interior of the vehicle as well as provide for vehicle control customization. For example, the driver can customize what instruments they would like to see in the instrument cluster, where and what the steering wheel is located, whether the vehicle presents as automatic or a manual transmission, a location of a window control interface, a location of a door control interface, etc. Additionally, the vehicle may include one or more augmented windows (e.g., windshield, sunroof, etc.). An augmented window is a window that includes at least some LF display modules.

In some embodiments, the LF display system may include elements that enable the system to simultaneously emit at least one type of energy, and, simultaneously, absorb at least one type of energy for the purpose of responding to the users and providing instructions to a vehicle. For example, a LF display system can emit both holographic objects for viewing as well as ultrasonic waves for haptic perception, and simultaneously absorb imaging information for tracking of viewers and other scene analysis, while also absorbing ultrasonic waves to detect touch response by the users. As an example, such a system may project a holographic steering wheel, which when virtually “touched” by a user, rotates in accordance with the touch stimuli. The display system components that perform energy sensing of the environment may be integrated into the display surface via bidirectional energy elements that both emit and absorb energy, or they may be dedicated sensors that are separate from the display surface, such as ultrasonic speakers and imaging capture devices such as cameras.

In some embodiments, both an interior surface and an exterior surface of a vehicle includes LF display modules. One advantage of this arrangement is an ability to substantially mitigate blind spots for a driver of the vehicle. For example, the vehicle may include cameras (e.g., as part of the LF display modules) that capture images of a local area surrounding the vehicle. The LF display system uses the captured images to generate holographic content that is then presented to the driver using the LF display modules within the interior of the vehicle. The LF display modules within the interior of the vehicle present holographic content that correspond to the captured images—effectively allowing the driver to look “through” what would normally be an opaque object (i.e., part of the automobile) to see the object in the driver's blind spot.

### Light Field Display System Overview

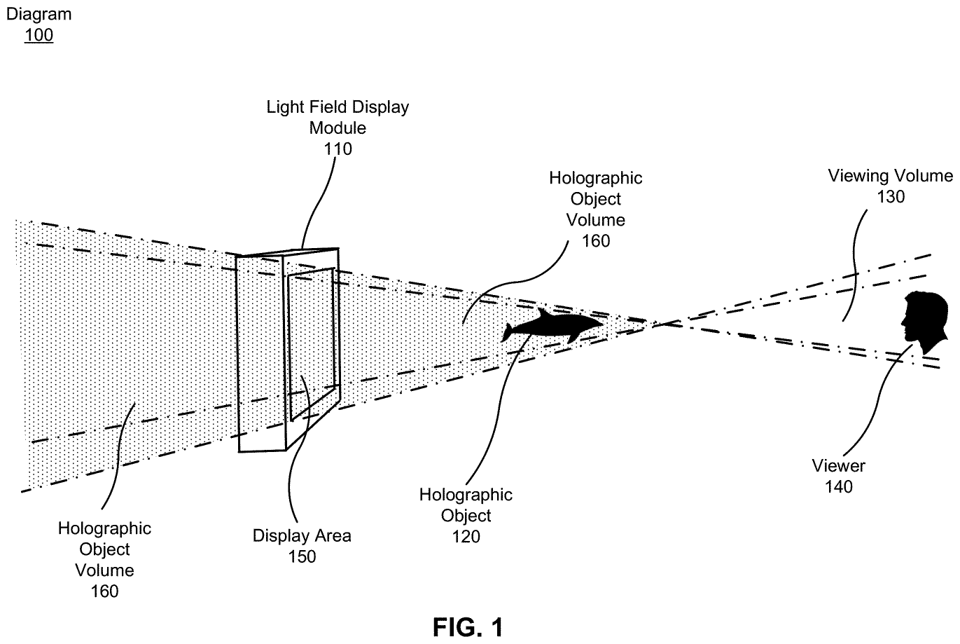

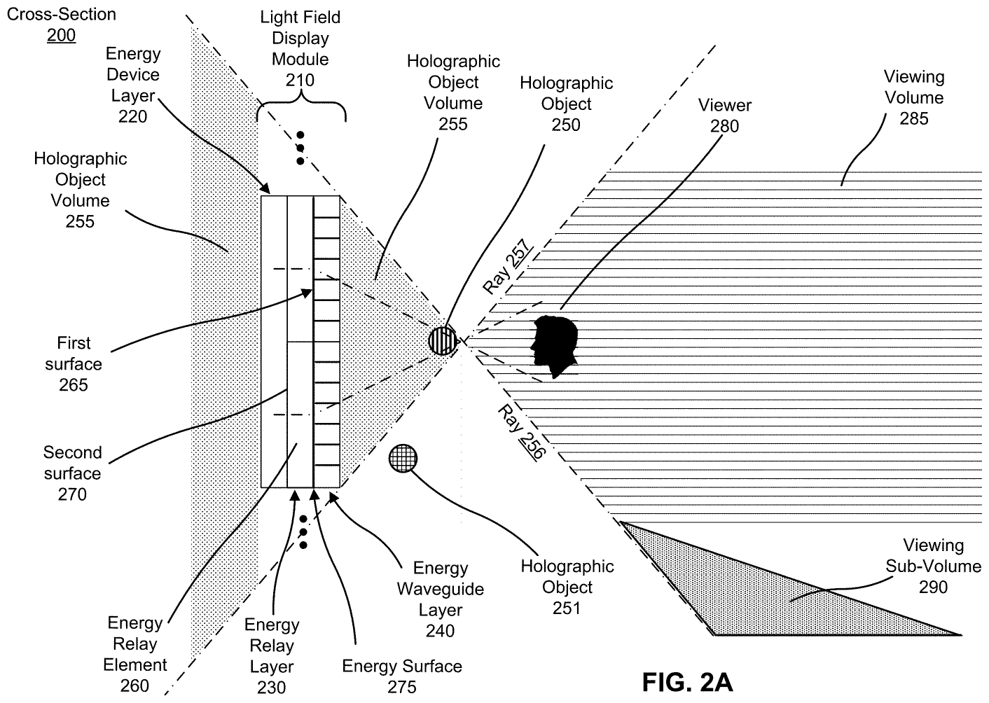

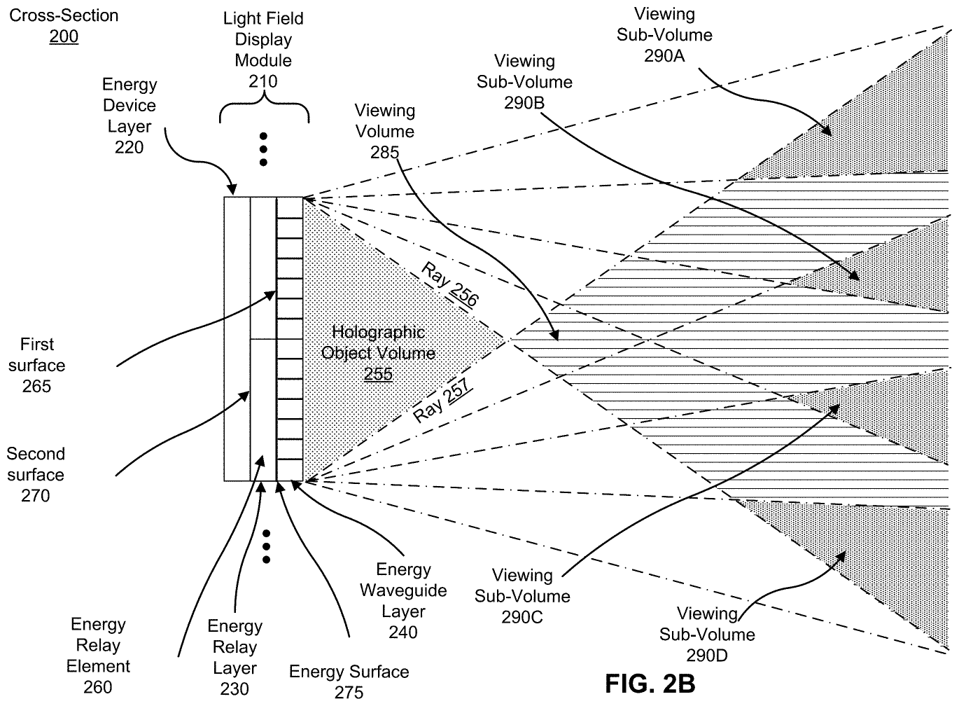

FIG. 1 is a diagram 100 of a light field (LF) display module 110 presenting a holographic object 120, in accordance with one or more embodiments. The LF display module 110 is part of a light field (LF) display system. The LF display system presents holographic content including at least one holographic object using one or more LF display modules. The LF display system can present holographic content to one or multiple viewers. In some embodiments, the LF display system may also augment the holographic content with other sensory content (e.g., touch, audio, smell, temperature, etc.). For example, as discussed below, the projection of focused ultrasonic sound waves may generate a mid-air tactile sensation that can simulate a surface of some or all of a holographic object. The LF display system includes one or more LF display modules 110, and is discussed in detail below with regard to FIGS. 2-5.

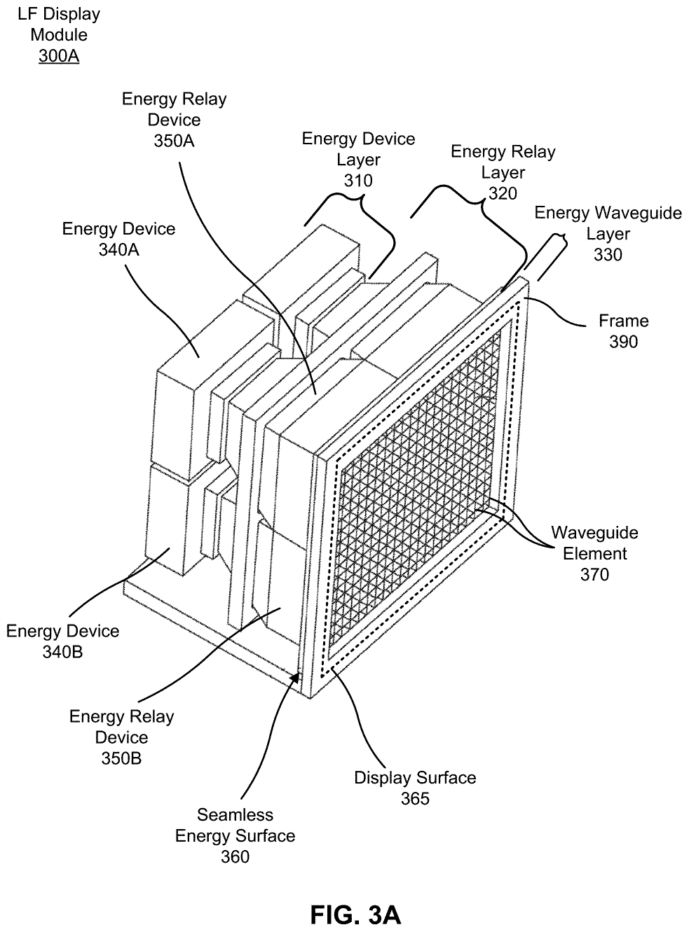

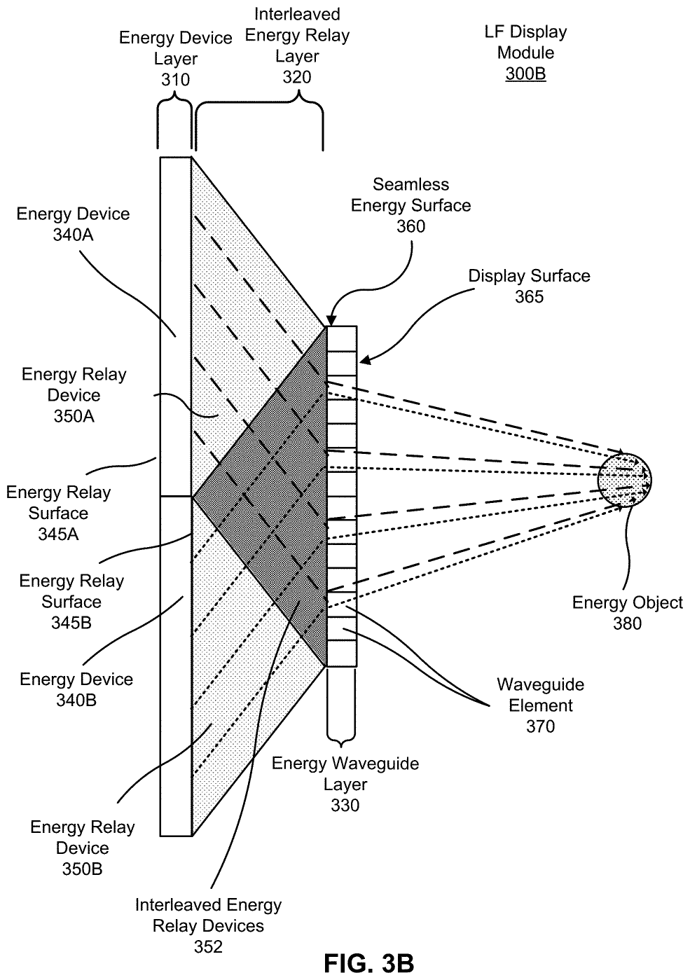

The LF display module 110 is a holographic display that presents holographic objects (e.g., the holographic object 120) to one or more viewers (e.g., viewer 140). The LF display module 110 includes an energy device layer (e.g., an emissive electronic display or acoustic projection device) and an energy waveguide layer (e.g., optical lens array). Additionally, the LF display module 110 may include an energy relay layer for the purpose of combining multiple energy sources or detectors together to form a single surface. At a high-level, the energy device layer generates energy (e.g., holographic content) that is then directed using the energy waveguide layer to a region in space in accordance with one or more four-dimensional (4D) light field functions. The LF display module 110 may also project and/or sense one or more types of energy simultaneously. For example, LF display module 110 may be able to project a holographic image as well as an ultrasonic tactile surface in a viewing volume, while simultaneously detecting imaging data from the viewing volume. The operation of the LF display module 110 is discussed in more detail below with regard to FIGS. 2A-3B.

The LF display module 110 generates holographic objects within a holographic object volume 160 using one or more 4D light field functions (e.g., derived from a plenoptic function). The holographic objects can be three-dimensional (3D), two-dimensional (2D), or some combination thereof. Moreover, the holographic objects may be polychromatic (e.g., full color). The holographic objects may be projected in front of the screen plane, behind the screen plane, or split by the screen plane. A holographic object 120 can be presented such that it is perceived anywhere within the holographic object volume 160. A holographic object within the holographic object volume 160 may appear to a viewer 140 to be floating in space.

A holographic object volume 160 represents a volume in which holographic objects may be perceived by a viewer 140. The holographic object volume 160 can extend in front of the surface of the display area 150 (i.e., towards the viewer 140) such that holographic objects can be presented in front of the plane of the display area 150. Additionally, the holographic object volume 160 can extend behind the surface of the display area 150 (i.e., away from the viewer 140), allowing for holographic objects to be presented as if they are behind the plane of the display area 150. In other words, the holographic object volume 160 may include all the rays of light that originate (e.g., are projected) from a display area 150 and can converge to create a holographic object. Herein, light rays may converge at a point that is in front of the display surface, at the display surface, or behind the display surface. More simply, the holographic object volume 160 encompasses all of the volume from which a holographic object may be perceived by a viewer.

A viewing volume 130 is a volume of space from which holographic objects (e.g., holographic object 120) presented within a holographic object volume 160 by the LF display system are fully viewable. The holographic objects may be presented within the holographic object volume 160, and viewed within a viewing volume 130, such that they are indistinguishable from actual objects. A holographic object is formed by projecting the same light rays that would be generated from the surface of the object were it physically present.

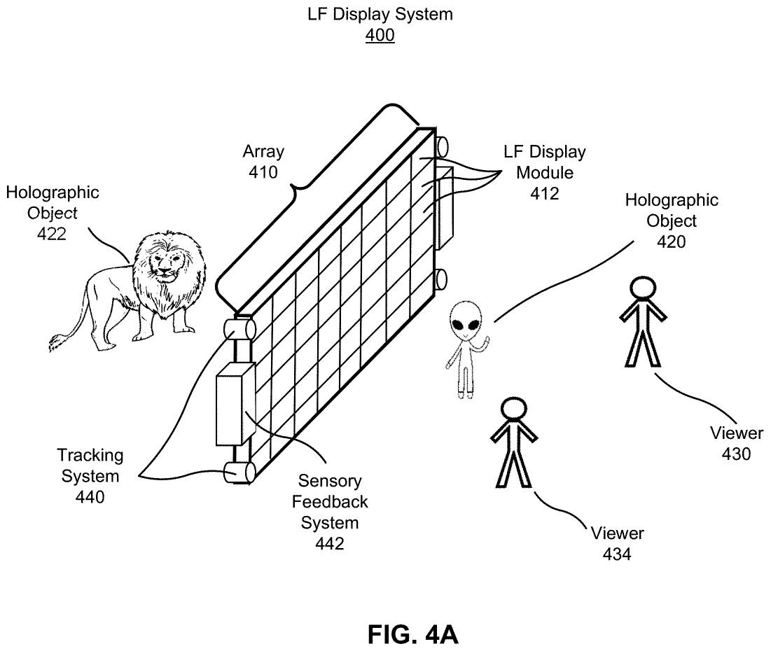

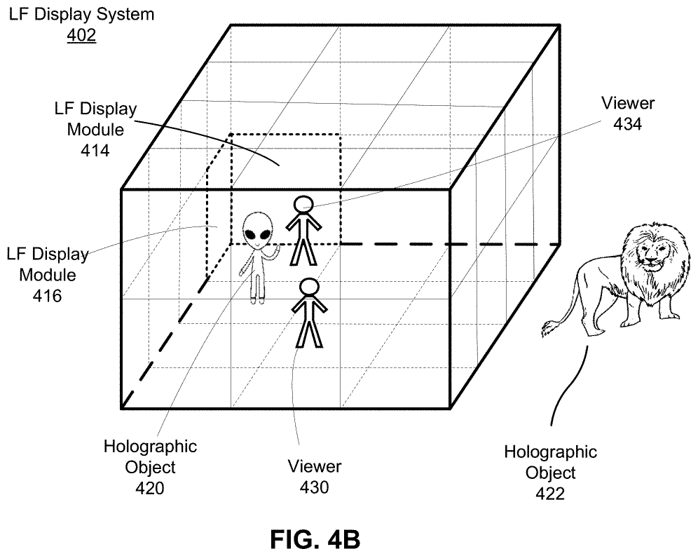

In some cases, the holographic object volume 160 and the corresponding viewing volume 130 may be relatively small—such that it is designed for a single viewer. In other embodiments, as discussed in detail below with regard to, e.g., FIGS. 4A, 4B, and 6A-13B, the LF display modules may be enlarged and/or tiled to create larger holographic object volumes and corresponding viewing volumes that can accommodate a large range of viewers (e.g., 1 to thousands). The LF display modules presented in this disclosure may be built so that the full surface of the LF display contains holographic imaging optics, with no inactive or dead space, and without any need for bezels. In these embodiments, the LF display modules may be tiled so that the imaging area is continuous across the seam between LF display modules, and the bond line between the tiled modules is virtually undetectable using the visual acuity of the eye. Notably, in some configurations, some portion of the display surface may not include holographic imaging optics, although they are not described in detail herein.

The flexible size and/or shape of a viewing volume 130 allows for viewers to be unconstrained within the viewing volume 130. For example, a viewer 140 can move to a different position within a viewing volume 130 and see a different view of the holographic object 120 from the corresponding perspective. To illustrate, referring to FIG. 1, the viewer 140 is at a first position relative to the holographic object 120 such that the holographic object 120 appears to be a head-on view of a dolphin. The viewer 140 may move to other locations relative to the holographic object 120 to see different views of the dolphin. For example, the viewer 140 may move such that he/she sees a left side of the dolphin, a right side of the dolphin, etc., much like if the viewer 140 was looking at an actual dolphin and changed his/her relative position to the actual dolphin to see different views of the dolphin. In some embodiments, the holographic object 120 is visible to all viewers within the viewing volume 130 that have an unobstructed line (i.e., not blocked by an object/person) of sight to the holographic object 120. These viewers may be unconstrained such that they can move around within the viewing volume to see different perspectives of the holographic object 120. Accordingly, the LF display system may present holographic objects such that a plurality of unconstrained viewers may simultaneously see different perspectives of the holographic objects in real-world space as if the holographic objects were physically present.

In contrast, conventional displays (e.g., stereoscopic, virtual reality, augmented reality, or mixed reality) generally require each viewer to wear some sort of external device (e.g., 3-D glasses, a near-eye display, or a head-mounted display) in order to see content. Additionally and/or alternatively, conventional displays may require that a viewer be constrained to a particular viewing position (e.g., in a chair that has fixed location relative to the display). For example, when viewing an object shown by a stereoscopic display, a viewer always focuses on the display surface, rather than on the object, and the display will always present just two views of an object that will follow a viewer who attempts to move around that perceived object, causing distortions in the perception of that object. With a light field display, however, viewers of a holographic object presented by the LF display system do not need to wear an external device, nor be confined to a particular position, in order to see the holographic object. The LF display system presents the holographic object in a manner that is visible to viewers in much the same way a physical object would be visible to the viewers, with no requirement of special eyewear, glasses, or a head-mounted accessory. Further, the viewer may view holographic content from any location within a viewing volume.

Notably, potential locations for holographic objects within the holographic object volume 160 are limited by the size of the volume. In order to increase the size of the holographic object volume 160, a size of a display area 150 of the LF display module 110 may be increased and/or multiple LF display modules may be tiled together in a manner that forms a seamless display surface. The seamless display surface has an effective display area that is larger than the display areas of the individual LF display modules. Some embodiments relating to tiling LF display modules are discussed below with regard to FIGS. 4A, 4B, and 6A-13B. As illustrated in FIG. 1, the display area 150 is rectangular resulting in a holographic object volume 160 that is a pyramid. In other embodiments, the display area may have some other shape (e.g., hexagonal), which also affects the shape of the corresponding viewing volume.

Additionally, while the above discussion focuses on presenting the holographic object 120 within a portion of the holographic object volume 160 that is between the LF display module 110 and the viewer 140, the LF display module 110 can additionally present content in the holographic object volume 160 behind the plane of the display area 150. For example, the LF display module 110 may make the display area 150 appear to be a surface of the ocean that the holographic object 120 is jumping out of And the displayed content may be such that the viewer 140 is able to look through the displayed surface to see marine life that is under the water. Moreover, the LF display system can generate content that seamlessly moves around the holographic object volume 160, including behind and in front of the plane of the display area 150.

FIG. 2A illustrates a cross section 200 of a portion of a LF display module 210, in accordance with one or more embodiments. The LF display module 210 may be the LF display module 110. In other embodiments, the LF display module 210 may be another LF display module with a different display area shape than display area 150. In the illustrated embodiment, the LF display module 210 includes an energy device layer 220, an energy relay layer 230, and an energy waveguide layer 240. Some embodiments of the LF display module 210 have different components than those described here. For example, in some embodiments, the LF display module 210 does not include the energy relay layer 230. Similarly, the functions can be distributed among the components in a different manner than is described here.

The display system described here presents an emission of energy that replicates the energy normally surrounding an object in the real world. Here, emitted energy is directed towards a specific direction from every coordinate on the display surface. In other words, the various coordinates on the display surface act as projection locations for emitted energy. The directed energy from the display surface enables convergence of many rays of energy, which, thereby, can create holographic objects. For visible light, for example, the LF display will project a very large number of light rays from the projection locations that may converge at any point in the holographic object volume so they will appear to come from the surface of a real-world object located in this region of space from the perspective of a viewer that is located further away than the object being projected. In this way, the LF display is generating the rays of reflected light that would leave such an object's surface from the perspective of the viewer. The viewer perspective may change on any given holographic object, and the viewer will see a different view of that holographic object.

The energy device layer 220 includes one or more electronic displays (e.g., an emissive display such as an OLED) and one or more other energy projection and/or energy receiving devices as described herein. The one or more electronic displays are configured to display content in accordance with display instructions (e.g., from a controller of a LF display system). The one or more electronic displays include a plurality of pixels, each with an intensity that is individually controlled. Many types of commercial displays, such as emissive LED and OLED displays, may be used in the LF display.

The energy device layer 220 may also include one or more acoustic projection devices and/or one or more acoustic receiving devices. An acoustic projection device generates one or more pressure waves that complement the holographic object 250. The generated pressure waves may be, e.g., audible, ultrasonic, or some combination thereof. An array of ultrasonic pressure waves may be used for volumetric tactile sensation (e.g., at a surface of the holographic object 250). An audible pressure wave is used for providing audio content (e.g., immersive audio) that can complement the holographic object 250. For example, assuming the holographic object 250 is a dolphin, one or more acoustic projection devices may be used to (1) generate a tactile surface that is coincident with a surface of the dolphin such that viewers may touch the holographic object 250; and (2) provide audio content corresponding to noises a dolphin makes such as clicks, chirping, or chatter. An acoustic receiving device (e.g., a microphone or microphone array) may be configured to monitor ultrasonic and/or audible pressure waves within a local area of the LF display module 210.

The energy device layer 220 may also include one or more imaging sensors. An imaging sensor may be sensitive to light in a visible optical band, and in some cases may be sensitive to light in other bands (e.g., infrared). The imaging sensor may be, e.g., a complementary metal oxide semi-conductor (CMOS) array, a charged coupled device (CCD), an array of photodetectors, some other sensor that captures light, or some combination thereof. The LF display system may use data captured by the one or more imaging sensor for position location tracking of viewers.

In some configurations, the energy relay layer 230 relays energy (e.g., electromagnetic energy, mechanical pressure waves, etc.) between the energy device layer 220 and the energy waveguide layer 240. The energy relay layer 230 includes one or more energy relay elements 260. Each energy relay element includes a first surface 265 and a second surface 270, and it relays energy between the two surfaces. The first surface 265 of each energy relay element may be coupled to one or more energy devices (e.g., electronic display or acoustic projection device). An energy relay element may be composed of, e.g., glass, carbon, optical fiber, optical film, plastic, polymer, or some combination thereof. Additionally, in some embodiments, an energy relay element may adjust magnification (increase or decrease) of energy passing between the first surface 265 and the second surface 270. If the relay offers magnification, then the relay may take the form of an array of bonded tapered relays, called tapers, where the area of one end of the taper may be substantially larger than the opposite end. The large end of the tapers can be bonded together to form a seamless energy surface 275. One advantage is that space is created on the multiple small ends of each taper to accommodate the mechanical envelope of multiple energy sources, such as the bezels of multiple displays. This extra room allows the energy sources to be placed side-by-side on the small taper side, with each energy source having their active areas directing energy into the small taper surface and relayed to the large seamless energy surface. Another advantage to using tapered relays is that there is no non-imaging dead space on the combined seamless energy surface formed by the large end of the tapers. No border or bezel exists, and so the seamless energy surfaces can then be tiled together to form a larger surface with virtually no seams according to the visual acuity of the eye.

The second surfaces of adjacent energy relay elements come together to form an energy surface 275. In some embodiments, a separation between edges of adjacent energy relay elements is less than a minimum perceptible contour as defined by a visual acuity of a human eye having, for example, 20/40 vision, such that the energy surface 275 is effectively seamless from the perspective of a viewer 280 within a viewing volume 285. In other embodiments, the second surfaces of adjacent energy relay elements are fused together with processing steps that may include one or more of pressure, heat, and a chemical reaction, in such a way no seam exists between them. And still in other embodiments, an array of energy relay elements is formed by molding one side of a continuous block of relay material into an array of small taper ends, each configured to transport energy from an energy device attached to the small tapered end into a single combined surface with a larger area which is never subdivided.

In some embodiments, one or more of the energy relay elements exhibit energy localization, where the energy transport efficiency in the longitudinal direction substantially normal to the surfaces 265 and 270 is much higher than the transport efficiency in the perpendicular transverse plane, and where the energy density is highly localized in this transverse plane as the energy wave propagates between surface 265 and surface 270. This localization of energy allows an energy distribution, such as an image, to be efficiency relayed between these surfaces without any significant loss in resolution.

The energy waveguide layer 240 directs energy from a location (e.g., a coordinate) on the energy surface 275 into a specific energy propagation path outward from the display surface into the holographic viewing volume 285 using waveguide elements in the energy waveguide layer 240. The energy propagation path is defined by two angular dimensions determined at least by the energy surface coordinate location relative to the waveguide. The waveguide is associated with a spatial 2D coordinate. Together, these four coordinates form a four-dimensional (4D) energy field. As an example, for electromagnetic energy, the waveguide elements in the energy waveguide layer 240 direct light from positions on the seamless energy surface 275 along different propagation directions through the viewing volume 285. In various examples, the light is directed in accordance with a 4D light field function to form the holographic object 250 within the holographic object volume 255.

Each waveguide element in the energy waveguide layer 240 may be, for example, a lenslet composed of one or more elements. In some configurations, the lenslet may be a positive lens. The positive lens may have a surface profile that is spherical, aspherical, or freeform. Additionally, in some embodiments, some or all of the waveguide elements may include one or more additional optical components. An additional optical component may be, e.g., an energy-inhibiting structure such as a baffle, a positive lens, a negative lens, a spherical lens, an aspherical lens, a freeform lens, a liquid crystal lens, a liquid lens, a refractive element, a diffractive element, or some combination thereof. In some embodiments, the lenslet and/or at least one of the additional optical components is able to dynamically adjust its optical power. For example, the lenslet may be a liquid crystal lens or a liquid lens. Dynamic adjustment of a surface profile the lenslet and/or at least one additional optical component may provide additional directional control of light projected from a waveguide element.

In the illustrated example, the holographic object volume 255 of the LF display has boundaries formed by light ray 256 and light ray 257, but could be formed by other rays. The holographic object volume 255 is a continuous volume that extends both in front (i.e., towards the viewer 280) of the energy waveguide layer 240 and behind it (i.e., away from the viewer 280). In the illustrated example, ray 256 and ray 257 are projected from opposite edges of the LF display module 210 at the highest angle relative to the normal to the display surface 277 that may be perceived by a user, but these could be other projected rays. The rays define the field-of-view of the display, and, thus, define the boundaries for the holographic viewing volume 285. In some cases, the rays define a holographic viewing volume where the full display can be observed without vignetting (e.g., an ideal viewing volume). As the field of view of the display increases, the convergence point of ray 256 and ray 257 will be closer to the display. Thus, a display having a larger field of view allows a viewer 280 to see the full display at a closer viewing distance. Additionally, ray 256 and 257 may form an ideal holographic object volume. Holographic objects presented in an ideal holographic object volume can be seen anywhere in the viewing volume 285.

In some examples, holographic objects may be presented to only a portion of the viewing volume 285. In other words, holographic object volumes may be divided into any number of viewing sub-volumes (e.g., viewing sub-volume 290). Additionally, holographic objects can be projected outside of the holographic object volume 255. For example, holographic object 251 is presented outside of holographic object volume 255. Because the holographic object 251 is presented outside of the holographic object volume 255 it cannot be viewed from every location in the viewing volume 285. For example, holographic object 251 may be visible from a location in viewing sub-volume 290, but not visible from the location of the viewer 280.

For example, we turn to FIG. 2B to illustrate viewing holographic content from different viewing sub-volumes. FIG. 2B illustrates a cross section 200 of a portion of a LF display module, in accordance with one or more embodiments. The cross-section of FIG. 2B is the same as the cross-section of FIG. 2A. However, FIG. 2B illustrates a different set of light rays projected from the LF display module 210. Ray 256 and ray 257 still form a holographic object volume 255 and a viewing volume 285. However, as shown, rays projected from the top of the LF display module 210 and the bottom of the LF display module 210 overlap to form various viewing sub-volumes (e.g., view sub-volumes 290A, 290B, 290C, and 290D) within the viewing volume 285. A viewer in the first viewing sub-volume (e.g., 290A) may be able to perceive holographic content presented in the holographic object volume 255 that viewers in the other viewing sub-volumes (e.g., 290B, 290C, and 290D) are unable to perceive.

More simply, as illustrated in FIG. 2A, holographic object volume 255 is a volume in which holographic objects may be presented by LF display system such that they may be perceived by viewers (e.g., viewer 280) in viewing volume 285. In this way, the viewing volume 285 is an example of an ideal viewing volume, while the holographic object volume 255 is an example of an ideal object volume. However, in various configurations, viewers may perceive holographic objects presented by LF display system 200 in other example holographic object volumes such that viewers in other example viewing volumes. More generally, an “eye-line guideline” applies when viewing holographic content projected from an LF display module. The eye-line guideline asserts that the line formed by a viewer's eye position and a holographic object being viewed must intersect a LF display surface.

When viewing holographic content presented by the LF display module 210, each eye of the viewer 280 sees a different perspective of the holographic object 250 because the holographic content is presented according to a 4D light field function. Moreover, as the viewer 280 moves within the viewing volume 285 he/she would also see different perspectives of the holographic object 250 as would other viewers within the viewing volume 285. As will be appreciated by one of ordinary skill in the art, a 4D light field function is well known in the art and will not be elaborated further herein.

As described in more detail herein, in some embodiments, the LF display can project more than one type of energy. For example, the LF display may project two types of energy, such as, for example, mechanical energy and electromagnetic energy. In this configuration, energy relay layer 230 may include two separate energy relays which are interleaved together at the energy surface 275, but are separated such that the energy is relayed to two different energy device layers 220. Here, one relay may be configured to transport electromagnetic energy, while another relay may be configured to transport mechanical energy. In some embodiments, the mechanical energy may be projected from locations between the electromagnetic waveguide elements on the energy waveguide layer 240, helping form structures that inhibit light from being transported from one electromagnetic waveguide element to another. In some embodiments, the energy waveguide layer 240 may also include waveguide elements that transport focused ultrasound along specific propagation paths in accordance with display instructions from a controller.

Note that in alternate embodiments (not shown), the LF display module 210 does not include the energy relay layer 230. In this case, the energy surface 275 is an emission surface formed using one or more adjacent electronic displays within the energy device layer 220. And in some embodiments, with no energy relay layer, a separation between edges of adjacent electronic displays is less than a minimum perceptible contour as defined by a visual acuity of a human eye having 20/40 vision, such that the energy surface is effectively seamless from the perspective of the viewer 280 within the viewing volume 285.

### LF Display Modules

FIG. 3A is a perspective view of a LF display module 300A, in accordance with one or more embodiments. The LF display module 300A may be the LF display module 110 and/or the LF display module 210. In other embodiments, the LF display module 300A may be some other LF display module. In the illustrated embodiment, the LF display module 300A includes an energy device layer 310, and energy relay layer 320, and an energy waveguide layer 330. The LF display module 300A is configured to present holographic content from a display surface 365 as described herein. For convenience, the display surface 365 is illustrated as a dashed outline on the frame 390 of the LF display module 300A, but is, more accurately, the surface directly in front of waveguide elements bounded by the inner rim of the frame 390. Some embodiments of the LF display module 300A have different components than those described here. For example, in some embodiments, the LF display module 300A does not include the energy relay layer 320. Similarly, the functions can be distributed among the components in a different manner than is described here.

The energy device layer 310 is an embodiment of the energy device layer 220. The energy device layer 310 includes four energy devices 340 (three are visible in the figure). The energy devices 340 may all be the same type (e.g., all electronic displays), or may include one or more different types (e.g., includes electronic displays and at least one acoustic energy device).

The energy relay layer 320 is an embodiment of the energy relay layer 230. The energy relay layer 320 includes four energy relay devices 350 (three are visible in the figure). The energy relay devices 350 may all relay the same type of energy (e.g., light), or may relay one or more different types (e.g., light and sound). Each of the relay devices 350 includes a first surface and a second surface, the second surface of the energy relay devices 350 being arranged to form a singular seamless energy surface 360. In the illustrated embodiment, each of the energy relay devices 350 are tapered such that the first surface has a smaller surface area than the second surface, which allows accommodation for the mechanical envelopes of the energy devices 340 on the small end of the tapers. This also allows the seamless energy surface to be borderless, since the entire area can project energy. This means that this seamless energy surface can be tiled by placing multiple instances of LF display module 300A together, without dead space or bezels, so that the entire combined surface is seamless. In other embodiments, the first surface and the second surface have the same surface area.

The energy waveguide layer 330 is an embodiment of the energy waveguide layer 240. The energy waveguide layer 330 includes a plurality of waveguide elements 370. As discussed above with respect to FIG. 2, the energy waveguide layer 330 is configured to direct energy from the seamless energy surface 360 along specific propagation paths in accordance with a 4D light field function to form a holographic object. Note that in the illustrated embodiment the energy waveguide layer 330 is bounded by a frame 390. In other embodiments, there is no frame 390 and/or a thickness of the frame 390 is reduced. Removal or reduction of thickness of the frame 390 can facilitate tiling the LF display module 300A with additional LF display modules.

Note that in the illustrated embodiment, the seamless energy surface 360 and the energy waveguide layer 330 are planar. In alternate embodiments, not shown, the seamless energy surface 360 and the energy waveguide layer 330 may be curved in one or more dimensions.

The LF display module 300A can be configured with additional energy sources that reside on the surface of the seamless energy surface, and allow the projection of an energy field in additional to the light field. In one embodiment, an acoustic energy field may be projected from electrostatic speakers (not illustrated) mounted at any number of locations on the seamless energy surface 360. Further, the electrostatic speakers of the LF display module 300A are positioned within the light field display module 300A such that the dual-energy surface simultaneously projects sound fields and holographic content (e.g., light). For example, the electrostatic speakers may be formed with one or more diaphragm elements that are transmissive to some wavelengths of electromagnetic energy, and driven with one or more conductive elements (e.g., planes which sandwich the one or more diaphragm elements). The electrostatic speakers may be mounted on to the seamless energy surface 360, so that the diaphragm elements cover some of the waveguide elements. The conductive electrodes of the speakers may be co-located with structures designed to inhibit light transmission between electromagnetic waveguides, and/or located at positions between electromagnetic waveguide elements (e.g., frame 390). In various configurations, the speakers can project an audible sound and/or many sources of focused ultrasonic energy that produces a haptic surface.

In some configurations an energy device 340 may sense energy. For example, an energy device may be a microphone, a light sensor, an acoustic transducer, etc. As such, the energy relay devices may also relay energy from the seamless energy surface 360 to the energy device layer 310. That is, the seamless energy surface 360 of the LF display module forms a bidirectional energy surface when the energy devices and energy relay devices 340 are configured to simultaneously emit and sense energy (e.g., emit light fields and sense sound).

More broadly, an energy device 340 of a LF display module 340 can be either an energy source or an energy sensor. The LF display module 300A can include various types of energy devices that act as energy sources and/or energy sensors to facilitate the projection of high quality holographic content to a user. Other sources and/or sensors may include thermal sensors or sources, infrared sensors or sources, image sensors or sources, mechanical energy transducers that generate acoustic energy, feedback sources, etc. Many other sensors or sources are possible. Further, the LF display modules can be tiled such that the LF display module can form an assembly that projects and senses multiple types of energy from a large aggregate seamless energy surface

In various embodiments of LF display module 300A, the seamless energy surface 360 can have various surface portions where each surface portion is configured to project and/or emit specific types of energy. For example, when the seamless energy surface is a dual-energy surface, the seamless energy surface 360 includes one or more surface portions that project electromagnetic energy, and one or more other surface portions that project ultrasonic energy. The surface portions that project ultrasonic energy may be located on the seamless energy surface 360 between electromagnetic waveguide elements, and/or co-located with structures designed to inhibit light transmission between electromagnetic waveguide elements. In an example where the seamless energy surface is a bidirectional energy surface, the energy relay layer 320 may include two types of energy relay devices interleaved at the seamless energy surface 360. In various embodiments, the seamless energy surface 360 may be configured such that portions of the surface under any particular waveguide element 370 are all energy sources, all energy sensors, or a mix of energy sources and energy sensors.

FIG. 3B is a cross-sectional view of a LF display module 300B which includes interleaved energy relay devices, in accordance with one or more embodiments. Energy relay device 350A transports energy between the energy relay first surface 345A connected to energy device 340A, and the seamless energy surface 360. Energy relay 350B transports energy between the energy relay first surface 345B connected to energy device 340B, and the seamless energy surface 360. Both relay devices are interleaved at interleaved energy relay device 352, which is connected to the seamless energy surface 360. In this configuration, surface 360 contains interleaved energy locations of both energy devices 340A and 340B, which may be energy sources or energy sensors. Accordingly, the LF display module 300B may be configured as either a dual energy projection device for projecting more than one type of energy, or as a bidirectional energy device for simultaneously projecting one type of energy and sensing another type of energy. The LF display module 300B may be the LF display module 110 and/or the LF display module 210. In other embodiments, the LF display module 300B may be some other LF display module.

The LF display module 300B includes many components similarly configured to those of LF display module 300A in FIG. 3A. For example, in the illustrated embodiment, the LF display module 300B includes an energy device layer 310, a seamless energy surface 360, and an energy waveguide layer 330 including at least the same functionality of those described in regards to FIG. 3A. Additionally, the LF display module 300B may present and/or receive energy from the display surface 365. Notably, the components of the LF display module 300B are alternatively connected and/or oriented than those of the LF display module 300A in FIG. 3A. Some embodiments of the LF display module 300B have different components than those described here. Similarly, the functions can be distributed among the components in a different manner than is described here. FIG. 3B illustrates the design of a single LF display module 300B that may be tiled to produce a dual energy projection surface or a bidirectional energy surface with a larger area.

In an embodiment, the LF display module 300B is a LF display module of a bidirectional LF display system. A bidirectional LF display system may simultaneously project energy and sense energy from the display surface 365. The seamless energy surface 360 contains both energy projecting and energy sensing locations that are closely interleaved on the seamless energy surface 360. Therefore, in the example of FIG. 3B, the energy relay layer 320 is configured in a different manner than the energy relay layer of FIG. 3A. For convenience, the energy relay layer of LF display module 300B will be referred to herein as the “interleaved energy relay layer.”

The interleaved energy relay layer 320 includes two legs: a first energy relay device 350A and a second energy relay device 350B. Each of the legs are illustrated as a lightly shaded area in FIG. 3B. Each of the legs may be made of a flexible relay material, and formed with a sufficient length to use with energy devices of various sizes and shapes. In some regions of the interleaved energy relay layer, the two legs are tightly interleaved together as they approach the seamless energy surface 360. In the illustrated example, the interleaved energy relay devices 352 are illustrated as a darkly shaded area.

While interleaved at the seamless energy surface 360, the energy relay devices are configured to relay energy to/from different energy devices. The energy devices are at energy device layer 310. As illustrated, energy device 340A is connected to energy relay device 350A and energy device 340B is connected to energy relay device 350B. In various embodiments, each energy device may be an energy source or energy sensor.

An energy waveguide layer 330 includes waveguide elements 370 to steer energy waves from the seamless energy surface 360 along projected paths towards a series of convergence points. In this example, a holographic object 380 is formed at the series of convergence points. Notably, as illustrated, the convergence of energy at the holographic object 380 occurs on the viewer side (i.e., the front side) of the display surface 365. However, in other examples, the convergence of energy may be anywhere in the holographic object volume, which extends both in front of the display surface 365 and behind the display surface 365. The waveguide elements 370 can simultaneously steer incoming energy to an energy device (e.g., an energy sensor), as described below.

In one example embodiment of LF display module 300B, an emissive display is used as an energy source (e.g., energy device 340A) and an imaging sensor is used as an energy sensor (e.g., energy device 340B). In this manner, the LF display module 300B can simultaneously project holographic content and detect light from the volume in front of the display surface 365. And in this embodiment of the LF display module 300B functions as both a LF display and an LF sensor.

In an embodiment, the LF display module 300B is configured to simultaneously project a light field in front of the display surface 365 and capture a light field from the front of the display surface 365. In this embodiment, the energy relay device 350A connects a first set of locations at the seamless energy surface 360 positioned under the waveguide elements 370 to an energy device 340A. In an example, energy device 340A is an emissive display having an array of source pixels. The energy relay device 340B connects a second set of locations at the seamless energy surface 360 positioned under waveguide elements 370 to an energy device 340B. In an example, the energy device 340B is an imaging sensor having an array of sensor pixels. The LF display module 300B may be configured such that the locations at the seamless energy surface 365 that are under a particular waveguide element 370 are all emissive display locations, all imaging sensor locations, or some combination of these locations. In other embodiments, the bidirectional energy surface can project and receive various other forms of energy.

In another example embodiment of the LF display module 300B, the LF display module is configured to project two different types of energy. For example, energy device 340A is an emissive display configured to emit electromagnetic energy and energy device 340B is an ultrasonic transducer configured to emit mechanical energy. As such, both light and sound can be projected from various locations at the seamless energy surface 360. In this configuration, energy relay device 350A connects the energy device 340A to the seamless energy surface 360 and relays the electromagnetic energy. The energy relay device is configured to have properties (e.g. varying refractive index) which make it efficient for transporting electromagnetic energy. Energy relay device 350B connects the energy device 340B to the seamless energy surface 360 and relays mechanical energy. Energy relay device 350B is configured to have properties for efficient transport of ultrasound energy (e.g. distribution of materials with different acoustic impedance). In some embodiments, the mechanical energy may be projected from locations between the waveguide elements 370 on the energy waveguide layer 330. The locations that project mechanical energy may form structures that serve to inhibit light from being transported from one electromagnetic waveguide element to another. In one example, a spatially separated array of locations that project ultrasonic mechanical energy can be configured to create three-dimensional haptic shapes and surfaces in mid-air. The surfaces may coincide with projected holographic objects (e.g., holographic object 380). In some examples, phase delays and amplitude variations across the array can assist in creating the haptic shapes.

In various embodiments, the LF display module 300B with interleaved energy relay devices may include multiple energy device layers with each energy device layer including a specific type of energy device. In these examples, the energy relay layers are configured to relay the appropriate type of energy between the seamless energy surface 360 and the energy device layer 310.

### Tiled LF Display Modules

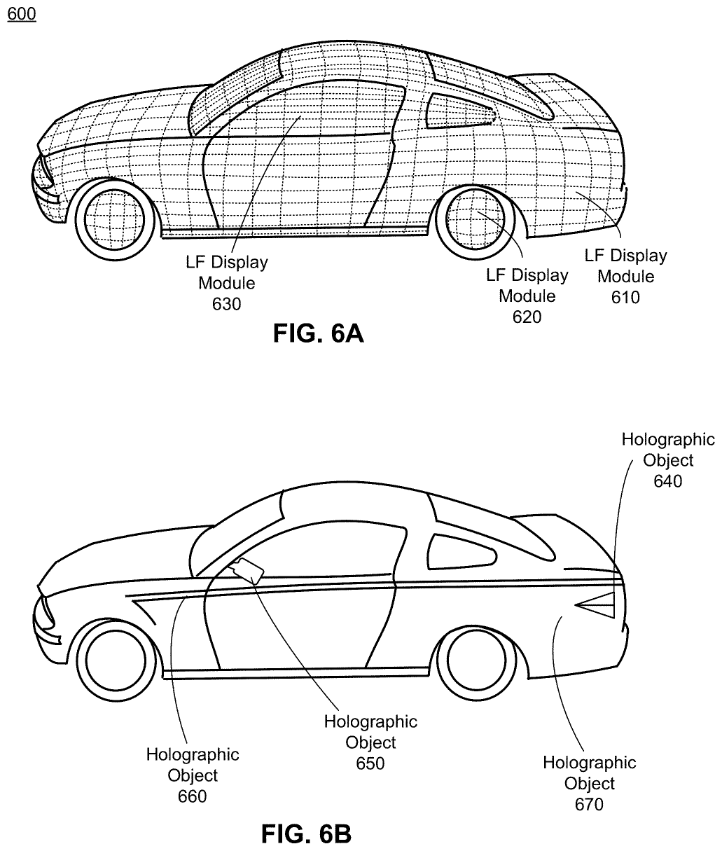

FIG. 4A is a perspective view of a portion of LF display system 400 that is tiled in two dimensions to form a single-sided seamless surface environment, in accordance with one or more embodiments. The LF display system 400 includes a plurality of LF display modules that are tiled to form an array 410. More explicitly, each of the small squares in the array 410 represents a tiled LF display module 412. The LF display module 412 may be the same as the LF display module 300A or 300B. The array 410 may cover, for example, some or all of a surface (e.g., a wall) of a room. The LF array may cover other surfaces, such as, for example, portions of an interior and/or exterior of an automobile as discussed below with regard to FIGS. 6A-13B.

The array 410 may project one or more holographic objects. For example, in the illustrated embodiment, the array 410 projects a holographic object 420 and a holographic object 422. Tiling of the LF display modules 412 allows for a much larger viewing volume as well as allows for objects to be projected out farther distances from the array 410. For example, in the illustrated embodiment, the viewing volume is, approximately, the entire area in front of and behind the array 410 rather than a localized volume in front of (and behind) a LF display module 412.

In some embodiments, the LF display system 400 presents the holographic object 420 to a viewer 430 and a viewer 434. The viewer 430 and the viewer 434 receive different perspectives of the holographic object 420. For example, the viewer 430 is presented with a direct view of the holographic object 420, whereas the viewer 434 is presented with a more oblique view of the holographic object 420. As the viewer 430 and/or the viewer 434 move, they are presented with different perspectives of the holographic object 420. This allows a viewer to visually interact with a holographic object by moving relative to the holographic object. For example, as the viewer 430 walks around a holographic object 420, the viewer 430 sees different sides of the holographic object 420 as long as the holographic object 420 remains in the holographic object volume of the array 410. Accordingly, the viewer 430 and the viewer 434 may simultaneously see the holographic object 420 in real-world space as if it is truly there. Additionally, the viewer 430 and the viewer 434 do not need to wear an external device in order to see the holographic object 420, as the holographic object 420 is visible to viewers in much the same way a physical object would be visible. Additionally, here, the holographic object 422 is illustrated behind the array because the viewing volume of the array extends behind the surface of the array. In this manner, the holographic object 422 may be presented to the viewer 430 and/or viewer 434.

In some embodiments, the LF display system 400 may include a tracking system that tracks positions of the viewer 430 and the viewer 434. In some embodiments, the tracked position is the position of a viewer. In other embodiments, the tracked position is that of the eyes of a viewer. The position tracking of the eye is different from gaze tracking which tracks where an eye is looking (e.g., uses orientation to determine gaze location). The eyes of the viewer 430 and the eyes of the viewer 434 are in different locations.

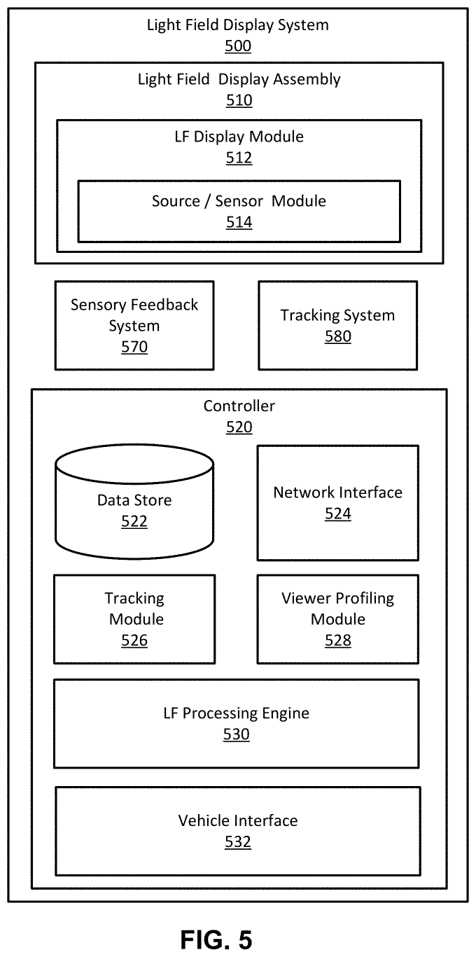

In various configurations, the LF display system 400 may include one or more tracking systems. For example, in the illustrated embodiment of FIG. 4A, LF display system includes a tracking system 440 that is external to the array 410. Here, the tracking system may be a camera system coupled to the array 410. External tracking systems are described in more detail in regards to FIG. 5. In other example embodiments, the tracking system may be incorporated into the array 410 as described herein. For example, an energy device (e.g., energy device 340) of one or more LF display modules 412 containing a bidirectional energy surface included in the array 410 may be configured to capture images of viewers in front of the array 410. In whichever case, the tracking system(s) of the LF display system 400 determines tracking information about the viewers (e.g., viewer 430 and/or viewer 434) viewing holographic content presented by the array 410.

Tracking information describes a position in space (e.g., relative to the tracking system) for the position of a viewer, or a position of a portion of a viewer (e.g. one or both eyes of a viewer, or the extremities of a viewer). A tracking system may use any number of depth determination techniques to determine tracking information. The depth determination techniques may include, e.g., structured light, time of flight, stereo imaging, some other depth determination technique, or some combination thereof. The tracking system may include various systems configured to determine tracking information. For example, the tracking system may include one or more infrared sources (e.g., structured light sources), one or more imaging sensors that can capture images in the infrared (e.g., red-blue-green-infrared camera), and a processor executing tracking algorithms. The tracking system may use the depth estimation techniques to determine positions of viewers and/or track movement of the viewers. In some embodiments, the LF display system 400 generates holographic objects based on tracked positions, motions, or gestures of the viewer 430 and/or the viewer 434 as described herein. For example, the LF display system 400 may generate a holographic object responsive to a viewer coming within a threshold distance of the array 410 and/or a particular position.

The LF display system 400 may present one or more holographic objects that are customized to each viewer based in part on the tracking information. For example, the viewer 430 may be presented with the holographic object 420, but not the holographic object 422. Similarly, the viewer 434 may be presented with the holographic object 422, but not the holographic object 420. For example, the LF display system 400 tracks a position of each of the viewer 430 and the viewer 434. The LF display system 400 determines a perspective of a holographic object that should be visible to a viewer based on their position relative to where the holographic object is to be presented. The LF display system 400 selectively projects light from specific pixels that correspond to the determined perspective. Accordingly, the viewer 434 and the viewer 430 can simultaneously have experiences that are, potentially, completely different. In other words, the LF display system 400 may present holographic content to viewing sub-volumes of the viewing volume (i.e., similar to the viewing sub-volumes 290A, 290B, 290C, and 290D shown in FIG. 2B). For example, as illustrated, the viewing volume is represented by all the space in front of and behind the array. In this example, because the LF display system 400 can track the position of the viewer 430, the LF display system 400 may present space content (e.g., holographic object 420) to a viewing sub-volume surrounding the viewer 430 and safari content (e.g., holographic object 422) to a viewing sub-volume surrounding the viewer 434. In contrast, conventional systems would have to use individual headsets to provide a similar experience.

In some embodiments the LF display system 400 may include one or more sensory feedback systems. The sensory feedback systems provide other sensory stimuli (e.g., tactile, audio, or smell) that augment the holographic objects 420 and 422. For example, in the illustrated embodiment of FIG. 4A, the LF display system 400 includes a sensory feedback system 442 external to the array 410. In one example, the sensory feedback system 442 may be an electrostatic speaker coupled to the array 410. External sensory feedback systems are described in more detail in regards to FIG. 5. In other example embodiments, the sensory feedback system may be incorporated into the array 410 as described herein. For example, an energy device (e.g., energy device 340A in FIG. 3B) of a LF display module 412 included in the array 410 may be configured to project ultrasonic energy to viewers in front of the array and/or receive imaging information from viewers in front of the array. In whichever case, the sensory feedback system presents and/or receives sensory content to/from the viewers (e.g., viewer 430 and/or viewer 434) viewing holographic content (e.g., holographic object 420 and/or holographic objected 422) presented by the array 410.

The LF display system 400 may include a sensory feedback system 442 that includes one or more acoustic projection devices external to the array. Alternatively or additionally, the LF display system 400 may include one or more acoustic projection devices integrated into the array 410 as described herein. The acoustic projection devices may include an array of ultrasonic sources configured to project a volumetric tactile surface. In some embodiments, the tactile surface may be coincident with a holographic object (e.g., at a surface of the holographic object 420) for one or more surfaces of a holographic object if a portion of a viewer gets within a threshold distance of the one or more surfaces. In other embodiments, the tactile surface may be separate and/or independent from a holographic object. The volumetric tactile sensation may allow the user to touch and feel surfaces of the holographic object. The plurality of acoustic projection devices may also project an audible pressure wave that provides audio content (e.g., immersive audio) to viewers. Accordingly, the ultrasonic pressure waves and/or the audible pressure waves can act to complement a holographic object.

In various embodiments, the LF display system 400 may provide other sensory stimuli based in part on a tracked position of a viewer. For example, the holographic object 422 illustrated in FIG. 4A is a lion, and the LF display system 400 may have the holographic object 422 roar both visually (i.e., the holographic object 422 appears to roar) and audibly (i.e., one or more acoustic projection devices project a pressure wave that the viewer 430 perceives as a lion's roar emanating from the holographic object 422.

Note that, in the illustrated configuration, the holographic viewing volume may be limited in a manner similar to the viewing volume 285 of the LF display system 200 in FIG. 2. This can limit the amount of perceived immersion that a viewer will experience with a single wall display unit. One way to address this is to use multiple LF display modules that are tiled along multiple sides as described below with respect to FIG. 4B-4F.

FIG. 4B is a perspective view of a portion of a LF display system 402 in a multi-sided seamless surface environment, in accordance with one or more embodiments. The LF display system 402 is substantially similar to the LF display system 400 except that the plurality of LF display modules are tiled to create a multi-sided seamless surface environment. More specifically, the LF display modules are tiled to form an array that is a six-sided aggregated seamless surface environment. In FIG. 4B, the plurality of LF display modules cover all the walls, the ceiling, and the floor of a room. In some cases, the room may be defined as an interior portion of an automobile. In other embodiments, the plurality of LF display modules may cover some, but not all of a wall, a floor, a ceiling, or some combination thereof. In other embodiments, a plurality of LF display modules are tiled to form some other aggregated seamless surface. For example, the walls may be curved such that a cylindrical aggregated energy environment is formed. Moreover, as described below with regard to FIGS. 6A-13B, in some embodiments, the LF display modules may be tiled to form a surface in an interior and/or exterior of an automobile.

The LF display system 402 may project one or more holographic objects. For example, in the illustrated embodiment the LF display system 402 projects the holographic object 420 into an area enclosed by the six-sided aggregated seamless surface environment. In this example, the viewing volume of the LF display system is also contained within the six-sided aggregated seamless surface environment. Note that, in the illustrated configuration, the viewer 434 may be positioned between the holographic object 420 and a LF display module 414 that is projecting energy (e.g., light and/or pressure waves) that is used to form the holographic object 420. Accordingly, the positioning of the viewer 434 may prevent the viewer 430 from perceiving the holographic object 420 formed from energy from the LF display module 414. However, in the illustrated configuration there is at least one other LF display module, e.g., a LF display module 416, that is unobstructed (e.g., by the viewer 434) and can project energy to form the holographic object 420 and be observed by the viewer 430. In this manner, occlusion by viewers in the space can cause some portion of the holographic projections to disappear, but the effect is much less than if only one side of the volume was populated with holographic display panels. Holographic object 422 is illustrated “outside” the walls of the enclosed six-sided aggregated seamless surface environment because the holographic object volume extends behind the aggregated surface. Thus, the viewer 430 and/or the viewer 434 can perceive the holographic object 422 as “outside” of a six-sided environment which they can move throughout.

As described above in reference to FIG. 4A, in some embodiments, the LF display system 402 actively tracks positions of viewers and may dynamically instruct different LF display modules to present holographic content based on the tracked positions. Accordingly, a multi-sided configuration can provide a more robust environment (e.g., relative to FIG. 4A) for providing holographic objects where unconstrained viewers are free to move throughout the area enclosed by the multi-sided seamless surface environment.

Notably, various LF display systems may have different configurations. Further, each configuration may have a particular orientation of surfaces that, in aggregate, form a seamless display surface (“aggregate surface”). That is, the LF display modules of a LF display system can be tiled to form a variety of aggregate surfaces. For example, in FIG. 4B, the LF display system 402 includes LF display modules tiled to form a six-sided aggregate surface that approximates the walls of a room. In some other examples, an aggregate surface may only occur on a portion of a surface (e.g., half of a wall) rather than a whole surface (e.g., an entire wall). Some examples are described herein.

In some configurations, the aggregate surface of a LF display system may include an aggregate surface configured to project energy towards a localized viewing volume. Projecting energy to a localized viewing volume allows for a higher quality viewing experience by, for example, increasing the density of projected energy in a specific viewing volume, increasing the FOV for the viewers in that volume, and bringing the viewing volume closer to the display surface.

### Control of a LF Display System

FIG. 5 is a block diagram of a LF display system 500, in accordance with one or more embodiments. The LF display system 500 comprises a LF display assembly 510 and a controller 520. The LF display assembly 510 includes one or more LF display modules 512 which project a light field. A LF display module 512 may include a source/sensor system 514 that includes an integrated energy source(s) and/or energy sensor(s) which project and/or sense other types of energy. The controller 520 includes a datastore 522, a network interface 524, a LF processing engine 530, and a vehicle interface 532. The controller 520 may also include a tracking module 526, and a viewer profiling module 528. In some embodiments, the LF display system 500 also includes a sensory feedback system 570 and a tracking system 580. The LF display systems described in the context of FIGS. 1-4B are embodiments of the LF display system 500. In other embodiments, the LF display system 500 comprises additional or fewer modules than those described herein. Similarly, the functions can be distributed among the modules and/or different entities in a different manner than is described here. Applications of the LF display system 500 are also discussed in detail below with regard to FIGS. 6A-13B.

The LF display assembly 510 provides holographic content in a holographic object volume that may be visible to viewers located within a viewing volume. The LF display assembly 510 may provide holographic content by executing display instructions received from the controller 520. The holographic content may include one or more holographic objects that are projected in front of an aggregate surface the LF display assembly 510, behind the aggregate surface of the LF display assembly 510, or some combination thereof. Generating display instructions with the controller 520 is described in more detail below.

The LF display assembly 510 provides holographic content using one or more LF display modules (e.g., any of the LF display module 110, the LF display system 200, and LF display module 300) included in an LF display assembly 510. For convenience, the one or more LF display modules may be described herein as LF display module 512. The LF display module 512 can be tiled to form a LF display assembly 510. The LF display modules 512 may be structured as various seamless surface environments (e.g., single sided, multi-sided, a wall of a vehicle, etc.). That is, the tiled LF display modules form an aggregate surface. As previously described, a LF display module 512 includes an energy device layer (e.g., energy device layer 220) and an energy waveguide layer (e.g., energy waveguide layer 240) that present holographic content. The LF display module 512 may also include an energy relay layer (e.g., energy relay layer 230) that transfers energy between the energy device layer and the energy waveguide layer when presenting holographic content.

The LF display module 512 may also include other integrated systems configured for energy projection and/or energy sensing as previously described. For example, a light field display module 512 may include any number of energy devices (e.g., energy device 340) configured to project and/or sense energy. For convenience, the integrated energy projection systems and integrated energy sensing systems of the LF display module 512 may be described herein, in aggregate, as the source/sensor system 514. The source/sensor system 514 is integrated within the LF display module 512, such that the source/sensor system 514 shares the same seamless energy surface with LF display module 512. In other words, the aggregate surface of an LF display assembly 510 includes the functionality of both the LF display module 512 and the source/sensor module 514. That is, an LF assembly 510 including a LF display module 512 with a source/sensor system 514 may project energy and/or sense energy while simultaneously projecting a light field. For example, the LF display assembly 510 may include a LF display module 512 and source/sensor system 514 configured as a dual-energy surface or bidirectional energy surface as previously described.

In some embodiments, the LF display system 500 augments the generated holographic content with other sensory content (e.g., coordinated touch, audio, or smell) using a sensory feedback system 570. The sensory feedback system 570 may augment the projection of holographic content by executing display instructions received from the controller 520. Generally, the sensory feedback system 570 includes any number of sensory feedback devices external to the LF display assembly 510 (e.g., sensory feedback system 442). Some example sensory feedback devices may include coordinated acoustic projecting and receiving devices, aroma projecting devices, temperature adjustment devices, force actuation devices, pressure sensors, transducers, etc. In some cases, the sensory feedback system 570 may have similar functionality to the light field display assembly 510 and vice versa. For example, both a sensory feedback system 570 and a light field display assembly 510 may be configured to generate a sound field. As another example, the sensory feedback system 570 may be configured to generate haptic surfaces while the light field display 510 assembly is not.

To illustrate, in an example embodiment of a light field display system 500, a sensory feedback system 570 may include acoustic projection devices (e.g., ultrasonic speakers). The acoustic projection devices are configured to generate one or more pressure waves that complement the holographic content when executing display instructions received from the controller 520. The generated pressure waves may be, e.g., audible (for sound), ultrasonic (for touch), or some combination thereof. Similarly, the sensory feedback system 570 may include an aroma projecting device. The aroma projecting device may be configured to provide scents to some, or all, of the target area when executing display instructions received from the controller. The aroma devices may be tied into an air circulation system of an automobile to coordinate air flow within the target area. Further, the sensory feedback system 570 may include a temperature adjustment device. The temperature adjustment device is configured to increase or decrease temperature in some, or all, of the target area when executing display instructions received from the controller 520.

In some embodiments, the sensory feedback system 570 is configured to receive input from viewers of the LF display system 500. In this case, the sensory feedback system 570 includes various sensory feedback devices for receiving input from viewers. The sensor feedback devices may include devices such as acoustic receiving devices (e.g., a microphone), pressure sensors, joysticks, motion detectors, transducers, etc. The sensory feedback system may transmit the detected input to the controller 520 to coordinate generating holographic content and/or sensory feedback.

To illustrate, in an example embodiment of a light field display assembly, a sensory feedback system 570 includes a microphone. The microphone is configured to record audio produced by one or more viewers (e.g., gasps, screams, laughter, etc.). The sensory feedback system 570 provides the recorded audio to the controller 520 as viewer input. The controller 520 may use the viewer input to generate holographic content. Similarly, the sensory feedback system 570 may include a pressure sensor. The pressure sensor is configured to measure forces applied by viewers to the pressure sensor. The sensory feedback system 570 may provide the measured forces to the controller 520 as viewer input.

In some embodiments, the LF display system 500 includes a tracking system 580. The tracking system 580 includes any number of tracking devices configured to determine the position, movement and/or characteristics of viewers in the target area. Generally, the tracking devices are external to the LF display assembly 510. Some example tracking devices include a camera assembly (“camera”), a depth sensor, structured light, a LIDAR system, a card scanning system, or any other tracking device that can track viewers within a target area (e.g., within an interior of a vehicle). Monitored behavior may include, e.g., is the user normally a driver or a passenger. Characteristics may include, e.g., name of a viewer, age of a viewer, vehicle controller preferences, vehicle interior preferences, vehicle exterior preferences, place of residence, any other demographic information, or some combination thereof.

The tracking system 580 may include one or more energy sources that illuminate some or all of the target area with light. However, in some cases, the target area is illuminated with natural light and/or ambient light from the LF display assembly 510 when presenting holographic content. The energy source projects light when executing instructions received from the controller 520. The light may be, e.g., a structured light pattern, a pulse of light (e.g., an IR flash), or some combination thereof. The tracking system may project light in the visible band (−380 nm to 750 nm), in the infrared (IR) band (−750 nm to 1700 nm), in the ultraviolet band (10 nm to 380 nm), some other portion of the electromagnetic spectrum, or some combination thereof. A source may include, e.g., a light emitted diode (LED), a micro LED, a laser diode, a TOF depth sensor, a tunable laser, etc.

The tracking system 580 may adjust one or more emission parameter when executing instructions received from the controller 520. An emission parameter is a parameter that affects how light is projected from a source of the tracking system 580. An emission parameter may include, e.g., brightness, pulse rate (to include continuous illumination), wavelength, pulse length, some other parameter that affects how light is projected from the source assembly, or some combination thereof. In one embodiment, a source projects pulses of light in a time-of-flight operation.

The camera of the tracking system 580 captures images of the light (e.g., structured light pattern) reflected from the target area. The camera captures images when executing tracking instructions received from the controller 520. As previously described, the light may be projected by a source of the tracking system 580. The camera may include one or more cameras. That is, a camera may be, e.g., an array (1D or 2D) of photodiodes, a CCD sensor, a CMOS sensor, some other device that detects some or all of the light project by the tracking system 580, or some combination thereof. In an embodiment, the tracking system 580 may contain a light field camera external to the LF display assembly 510. In other embodiments, the cameras are included as part of the LF display module included in the LF display assembly 510. For example, as previously described, if the energy relay element of a light field module 512 is a bidirectional energy layer which interleaves both emissive displays and imaging sensors at the energy device layer 220, the LF display assembly 510 can be configured to simultaneously project light fields and record imaging information from the viewing area in front of the display. In one embodiment, the captured images from the bidirectional energy surface form a light field camera. The camera provides captured images to the controller 520.

The camera of the tracking system 580 may adjust one or more imaging parameters when executing tracking instructions received from the controller 520. An imaging parameter is a parameter that affects how the camera captures images. An imaging parameter may include, e.g., frame rate, aperture, gain, exposure length, frame timing, rolling shutter or global shutter capture modes, some other parameter that affects how the camera captures images, or some combination thereof.

The controller 520 controls the LF display assembly 510 and any other components of the LF display system 500. The controller 520 comprises a data store 522, a network interface 524, a tracking module 526, a viewer profiling module 528, and a light field processing engine 530. In other embodiments, the controller 520 comprises additional or fewer modules than those described herein. Similarly, the functions can be distributed among the modules and/or different entities in a different manner than is described here. For example, the tracking module 526 may be part of the LF display assembly 510 or the tracking system 580.

The data store 522 is a memory that stores information for the LF display system 500. The stored information may include display instructions, tracking instructions, emission parameters, imaging parameters, a virtual model of a target area, tracking information, images captured by the camera, one or more viewer profiles, calibration data for the light field display assembly 510, configuration data for the LF display system 510 including resolution and orientation of LF modules 512, desired viewing volume geometry, content for graphics creation including 3D models, scenes and environments, materials and textures, other information that may be used by the LF display system 500, or some combination thereof. The data store 522 is a memory, such as a read only memory (ROM), dynamic random access memory (DRAM), static random access memory (SRAM), or some combination thereof.

The network interface 524 allows the light field display system to communicate with other systems or environments via a network. In one example, the LF display system 500 receives holographic content from a remote light field display system via the network interface 524. In another example, the LF display system 500 transmits holographic content to a remote data store using the network interface 524.

The tracking module 526 tracks viewers viewing content presented by the LF display system 500. To do so, the tracking module 526 generates tracking instructions that control operation of the source(s) and/or the camera(s) of the tracking system 580, and provides the tracking instructions to the tracking system 580. The tracking system 580 executes the tracking instructions and provides tracking input to the tracking module 526.

The tracking module 526 may determine a position of one or more viewers within the target area (e.g., sitting in the seats of an automobile, standing outside of the automobile). The determined position may be relative to, e.g., some reference point (e.g., a display surface). In other embodiments, the determined position may be within the virtual model of the target area. The tracked position may be, e.g., the tracked position of a viewer and/or a tracked position of a portion of a viewer (e.g., eye location, hand location, etc.). The tracking module 526 determines the position using one or more captured images from the cameras of the tracking system 580. The cameras of the tracking system 580 may be distributed about the LF display system 500, and can capture images in stereo, allowing for the tracking module 526 to passively track viewers. In other embodiments, the tracking module 526 actively tracks viewers. That is, the tracking system 580 illuminates some portion of the target area, images the target area, and the tracking module 526 uses time of flight and/or structured light depth determination techniques to determine position. The tracking module 526 generates tracking information using the determined positions.

The tracking module 526 may also receive tracking information as inputs from viewers of the LF display system 500. The tracking information may include body movements (i.e., gestures) that correspond to various input options that the viewer is provided by the LF display system 500. A gesture is a movement of the body that can be mapped to a particular input (e.g., request to make a change to a holographic object). Gestures may include, e.g., making a fist, swiping an extended finger in a particular direction, a pinching motion, a waiving motion, a reverse pinching motion, any other motion of a portion of the body, or some combination thereof. For example, the tracking module 526 may track a viewer's body movement and assign any various movement as an input to the LF processing engine 530. The tracking module 526 may provide the tracking information to the data store 522, the LF processing engine 530, the viewer profiling module 528, any other component of the LF display system 500, or some combination thereof

The LF display system 500 includes a viewer profiling module 528 configured to identify and profile viewers. The viewer profiling module 528 generates a profile of a viewer (or viewers) that views holographic content displayed by a LF display system 500. The viewer profiling module 528 generates a viewer profile based, in part, on viewer input and monitored viewer behavior, actions, and reactions. The viewer profiling module 528 can access information obtained from tracking system 580 (e.g., recorded images, videos, sound, etc.) and process that information to determine various information. In various examples, viewer profiling module 528 can use any number of machine vision or machine hearing algorithms to determine viewer behavior, actions, and reactions. Monitored viewer behavior can include, for example, smiles, cheering, clapping, laughing, fright, screams, excitement levels, recoiling, other changes in gestures, or movement by the viewers, etc.

More generally, a viewer profile may include any information received and/or determined about a viewer viewing holographic content from the LF display system. For example, each viewer profile may log actions or responses of that viewer to the content displayed by the LF display system 500. Some example information that can be included in a viewer profile are provided below.

The viewing profiling module 528 generates viewer profiles for users of a vehicle. The viewing profiling module 528 builds viewer profiles based in part on user input and monitored behavior. A viewing profile describes behavior for a viewer with respect to the LF display system 500 and one or more characteristics of the viewer. In some embodiments, the viewing profiling module 528 may receive characteristics from the user and/or infer characteristics based on the monitored behavior. Monitored behavior may include, e.g., is the user normally a driver or a passenger. Characteristics may include, e.g., name of a viewer, age of a viewer, vehicle controller preferences, vehicle interior preferences, vehicle exterior preferences, place of residence, any other demographic information, or some combination thereof.

Vehicle controller preferences describe a user's preferred configuration for holographic content that may be used to provide instruction to the vehicle. Holographic content that may be used to provide some instruction to the vehicle may include, e.g., a two-dimensional object, a three-dimensional object, a control switch, a control dial, a steering control interface (e.g., steering wheel), an instrument cluster, a music control interface (e.g., radio, music player), climate control interface (heater and/or air conditioning controls), windows control interfaces, door control interfaces (e.g., allow locking/unlocking of the door and/or opening of the door), a mapping control interface, a computer interface, a shifter, a control button, an entertainment video control interface (e.g., allows a vehicle occupant to control and/or present video content), some other control interface for the vehicle, or some combination thereof.

Vehicle interior preferences describes a user's preferred configuration for holographic content presented within the interior of the vehicle. For example, an instrument cluster (e.g., speedometer, tachometer, etc.), dash color, door panel color, amount of window tint, locations for holographic content within the interior (including holographic content that may be used to provide instruction to the vehicle).

Vehicle exterior preferences describes a user's preferred configuration for holographic content presented using LF display modules along an exterior of the vehicle. For example, the exterior preferences may describe vehicle color(s), what holographic objects are used to augment the external appearance of the vehicle (e.g., side mirrors, spoiler, hood scoop, etc.), locations for holographic content along the exterior, or some combination thereof

In some embodiments, the viewing profiling module 528 may directly update a viewer profile based on actions and/or responses of a user to holographic content displayed by the LF display system 500. In some embodiments, the viewing profiling module 528 provides the controller 520 with the identification of the viewers for building and storing viewer profiles.

In some embodiments, the data store 522 includes a viewer profile store that stores viewer profiles generated, updated, and/or maintained by the viewer profiling module 528. The viewer profile can be updated in the data store at any time by the viewer profiling module 528. For example, in an embodiment, the viewer profile store receives and stores information regarding a particular viewer in their viewer profile when the particular viewer views holographic content provided by the LF display system 500. In this example, the viewer profiling module 528 includes a facial recognition algorithm that may recognize viewers and positively identify as they view presented holographic content. To illustrate, as a viewer enters the target area of the LF display system 500, the tracking system 580 obtains an image of the viewer. The viewer profiling module 528 inputs the captured image and identifies the viewer's face using the facial recognition algorithm. The identified face is associated with a viewer profile in the profile store and, as such, all input information obtained about that viewer may be stored in their profile. The viewer profiling module may also utilize card identification scanners, voice identifiers, a radio-frequency identification (RFID) chip scanners, barcode scanners, etc. to positively identify a viewer.

Because the viewer profiling module 528 can positively identify viewers, the viewer profiling module 528 can determine each visit of each viewer to the LF display system 500. The viewer profiling module 528 may then store the time and date of each visit in the viewer profile for each viewer. Similarly, the viewer profiling module 528 may store received inputs from a viewer from any combination of the sensory feedback system 570, the tracking system 580, and/or the LF display assembly 510 each time they occur. The viewer profile system 528 may additionally receive further information about a viewer from other modules or components of the controller 520 which can then be stored with the viewer profile. Other components of the controller 520 may then also access the stored viewer profiles for determining subsequent content to be provided to that viewer.

The LF processing engine 530 generates 4D coordinates in a rasterized format (“rasterized data”) that, when executed by the LF display assembly 510, cause the LF display assembly 510 to present holographic content. The LF processing engine 530 may access the rasterized data from the data store 522. Additionally, the LF processing engine 530 may construct rasterized data from a vectorized data set. Vectorized data is described below. The LF processing engine 530 can also generate sensory instructions required to provide sensory content that augments the holographic objects. As described above, sensory instructions may generate, when executed by the LF display system 500, haptic surfaces, sound fields, and other forms of sensory energy supported by the LF display system 500. The LF processing engine 530 may access sensory instructions from the data store 522, or construct the sensory instructions form a vectorized data set. In aggregate, the 4D coordinates and sensory data represent display instructions executable by a LF display system to generate holographic and sensory content.

The amount of rasterized data describing the flow of energy through the various energy sources in a LF display system 500 is incredibly large. While it is possible to display the rasterized data on a LF display system 500 when accessed from a data store 522, it is untenable to efficiently transmit, receive (e.g., via a network interface 524), and subsequently display the rasterized data on a LF display system 500. Take, for example, rasterized data representing a short film for holographic projection by a LF display system 500. In this example, the LF display system 500 includes a display containing several gigapixels and the rasterized data contains information for each pixel location on the display. The corresponding size of the rasterized data is vast (e.g., many gigabytes per second of film display time), and unmanageable for efficient transfer over commercial networks via a network interface 524. The efficient transfer problem may be amplified for applications including live streaming of holographic content. An additional problem with merely storing rasterized data on data store 522 arises when an interactive experience is desired using inputs from the sensory feedback system 570 or the tracking module 526. To enable an interactive experience, the light field content generated by the LF processing engine 530 can be modified in real-time in response to sensory or tracking inputs. In other words, in some cases, LF content cannot simply be read from the data store 522.

Therefore, in some configurations, data representing holographic content for display by a LF display system 500 may be transferred to the LF processing engine 530 in a vectorized data format (“vectorized data”). Vectorized data may be orders of magnitude smaller than rasterized data. Further, vectorized data provides high image quality while having a data set size that enables efficient sharing of the data. For example, vectorized data may be a sparse data set derived from a denser data set. Thus, vectorized data may have an adjustable balance between image quality and data transmission size based on how sparse vectorized data is sampled from dense rasterized data. Tunable sampling to generate vectorized data enables optimization of image quality for a given network speed. Consequently, vectorized data enables efficient transmission of holographic content via a network interface 524. Vectorized data also enables holographic content to be live-streamed over a commercial network.

In summary, the LF processing engine 530 may generate holographic content derived from rasterized data accessed from the data store 522, vectorized data accessed from the data store 522, or vectorized data received via the network interface 524. In various configurations, vectorized data may be encoded before data transmission and decoded after reception by the LF controller 520. In some examples, the vectorized data is encoded for added data security and performance improvements related to data compression. For example, vectorized data received by the network interface may be encoded vectorized data received from a holographic streaming application. In some examples, vectorized data may require a decoder, the LF processing engine 530, or both of these to access information content encoded in vectorized data. The encoder and/or decoder systems may be available to customers or licensed to third-party vendors.

Vectorized data contains all the information for each of the sensory domains supported by a LF display system 500 in way that supports an interactive experience. For example, vectorized data for an interactive holographic experience includes any vectorized properties that can provide accurate physics for each of the sensory domains supported by a LF display system 500. Vectorized properties may include any properties that can be synthetically programmed, captured, computationally assessed, etc. A LF processing engine 530 may be configured to translate vectorized properties in vectorized data to rasterized data. The LF processing engine 530 may then project holographic content translated from the vectorized data from a LF display assembly 510. In various configurations, the vectorized properties may include one or more red/green/blue/alpha channel (RGBA)+depth images, multi view images with or without depth information at varying resolutions that may include one high-resolution center image and other views at a lower resolution, material properties such as albedo and reflectance, surface normals, other optical effects, surface identification, geometrical object coordinates, virtual camera coordinates, display plane locations, lighting coordinates, tactile stiffness for surfaces, tactile ductility, tactile strength, amplitude and coordinates of sound fields, environmental conditions, somatosensory energy vectors related to the mechanoreceptors for textures or temperature, audio, and any other sensory domain property. Many other vectorized properties are also possible.

The LF display system 500 may also dynamically update one or more holographic objects responsive to an instruction from the controller 520. For example, responsive to an event occurring, the controller 520 may instruct the LF display assembly 510 to present and/or update one or more holographic objects. Events may include, e.g., a user input (e.g., may be a gesture, verbal command, pressing a button, etc.), a navigation reminder, a cell phone call, a change in a vehicle status, some other event that may be pre-programmed, and some combination thereof. In some embodiments, responsive to a user input (e.g., a gesture), the controller 520 may adjust one or more of, an operating state of the vehicle (e.g., engine on/off, active gear, drive configuration, etc.), a control interface of the vehicle, a data indicator of the vehicle, an interior configuration (e.g., arrangement of holographic objects relative to driver, interior lighting, interior display information, radio volume, etc.) of the vehicle, at least one of the one or more holographic objects, an arrangement of the one or more holographic objects, transferring data on a network, executing a cell phone call (e.g., can also be a distress call), performing a navigational update, or some combination thereof. The operating state of the vehicle describes some aspect of vehicle operation. For example, the operating state may describe a change in the vehicle's speed, a transmission gear (e.g., drive, park, reverse, etc.), engine operations (on/off), drive configuration (e.g., 2-wheel drive, 4-wheel drive, etc.), headlight configuration (running lights on/off, high beams on/off, low beams on/off), mirror configuration, some other aspect of vehicle operation, or some combination thereof. Data indicators notify occupants of some aspect of the vehicle. Data indicators may include, e.g., a speedometer, turn signals, a tachometer, a gas gauge, low tire pressure warnings, oil warnings, a head-up display information, a navigation reminder, etc.

The LF display system 500 can also generate an interactive viewing experience. That is, holographic content may be responsive to input stimuli containing information about viewer locations, gestures, interactions, interactions with holographic content, or other information derived from the viewer profiling module 528, and/or tracking module 526. For example, in an embodiment, a LF processing system 500 creates an interactive viewing experience using vectorized data of a real-time performance received via a network interface 524. In another example, if a holographic object needs to move in a certain direction immediately in response to a viewer interaction, the LF processing engine 530 may update the render of the scene so the holographic object moves in that required direction. This may require the LF processing engine 530 to use a vectorized data set to render light fields real time based a 3D graphical scene with the proper object placement and movement, collision detection, occlusion, color, shading, lighting, etc., correctly responding to the viewer interaction. The LF processing engine 530 converts the vectorized data into rasterized data for presentation by the LF display assembly 510.

The rasterized data includes holographic content instructions and sensory instructions (display instructions) representing the real-time performance. The LF display assembly 510 simultaneously projects holographic and sensory content of the real-time performance by executing the display instructions. The LF display system 500 monitors viewer interactions (e.g., vocal response, touching, etc.) with the presented real-time performance with the tracking module 526 and viewer profiling module 528. In response to the viewer interactions, the LF processing engine creates an interactive experience by generating additional holographic and/or sensory content for display to the viewers.

To illustrate, consider an example embodiment of an LF display system 500 including a LF processing engine 530 that generates a plurality of holographic objects. For example, a plurality of holographic objects may be used to represent a shifter that appears a series of buttons corresponding to various transmission states (e.g., drive, reverse, neutral, etc.). The user may move to touch the holographic object representing the drive button. Correspondingly, the tracking system 580 tracks movement of the viewer's finger in relative to the holographic object. The movement of the user is recorded by the tracking system 580 and sent to the controller 520 and LF processing engine 530. In some embodiments, the LF processing engine 530 instructs the LF display assembly 510 to generate a tactile surface (e.g., using ultrasonic speakers) that corresponds to at least a portion of the holographic object and occupies substantially the same space as some or all of an exterior surface of the holographic object. The LF processing engine 530 uses the tracking information to dynamically instruct the LF display assembly 510 to move the location of the tactile surface along with a location of the rendered holographic object such that the user is given both a visual and tactile perception of pushing a physical button.

The holographic content track may also include spatial rendering information. That is, the holographic content track may indicate the spatial location for presenting holographic content in an interior of an automobile and/or along an exterior of an automobile. For example, the holographic content tract may indicate that certain holographic content is to be presented in some holographic viewing volumes while not others. To illustrate, LF processing engine 530 may present instrument controls along a dash of an automobile. Similarly, the holographic content track may indicate holographic content to present to some viewing volumes while not others. For example, the LF processing engine may present the instrument controls along the dash to the driver, but not to a passenger.

The LF processing engine 530 may also create holographic content for display by the LF display system 500. Importantly, here, creating holographic content for display is different from accessing, or receiving, holographic content for display. That is, when creating content, the LF processing engine 530 generates entirely new content for display rather than accessing previously generated and/or received content. The LF processing engine 530 can use information from the tracking system 580, the sensory feedback system 570, the viewer profiling module 528, the tracking module 528, or some combination thereof, to create holographic content for display. In some examples, LF processing engine 530 may access information from elements of the LF display system 500 (e.g., tracking information and/or a viewer profile), create holographic content based on that information, and display the created holographic content using the LF display system 500 in response. The created holographic content may be augmented with other sensory content (e.g., touch, audio, or smell) when displayed by the LF display system 500. Further, the LF display system 500 may store created holographic content such that it may be displayed in the future.

In some embodiments, the LF processing engine 530 incorporates an artificial intelligence (AI) model to create holographic content for display by the LF display system 500. The AI model may include supervised or unsupervised learning algorithms including but not limited to regression models, neural networks, classifiers, or any other AI algorithm. The AI model may be used to determine viewer preferences based on viewer information recorded by the LF display system 500 (e.g., by tracking system 580) which may include information on a viewer's behavior.

The AI model may access information from the data store 522 to create holographic content. For example, the AI model may access viewer information from a viewer profile or profiles in the data store 522 or may receive viewer information from the various components of the LF display system 500. To illustrate, the AI model may determine a vehicle occupant enjoys seeing certain automobile trim (exterior and/or interior). The AI model may determine the preference based on a group of viewer's positive reactions or responses to previously viewed automobile trim. That is, the AI model may create holographic content personalized to a set of viewers according to the learned preferences of those viewers. The AI model may also store the learned preferences of each viewer in the viewer profile store of the data store 522. In some examples, the AI model may create holographic for an individual viewer rather than a group of viewers.

One example of an AI model that can be used to identify characteristics of viewers, identify reactions, and/or generate holographic content based on the identified information is a convolutional neural network model with layers of nodes, in which values at nodes of a current layer are a transformation of values at nodes of a previous layer. Characteristics may include, e.g., name of a viewer, age of a viewer, vehicle controller preferences, vehicle interior preferences, vehicle exterior preferences, place of residence, any other demographic information, or some combination thereof. A transformation in the model is determined through a set of weights and parameters connecting the current layer and the previous layer. For example, and AI model may include five layers of nodes: layers A, B, C, D, and E. The transformation from layer A to layer B is given by a function W₁, the transformation from layer B to layer C is given by W₂, the transformation from layer C to layer D is given by W₃, and the transformation from layer D to layer E is given by W₄. In some examples, the transformation can also be determined through a set of weights and parameters used to transform between previous layers in the model. For example, the transformation W₄ from layer D to layer E can be based on parameters used to accomplish the transformation W₁ from layer A to B.

The input to the model can be an image taken by tracking system 580 encoded onto the convolutional layer A and the output of the model is holographic content decoded from the output layer E. Alternatively or additionally, the output may be a determined characteristic of a viewer in the image. In this example, the AI model identifies latent information in the image representing viewer characteristics in the identification layer C. The AI model reduces the dimensionality of the convolutional layer A to that of the identification layer C to identify any characteristics, actions, responses, etc. in the image. In some examples, the AI model then increases the dimensionality of the identification layer C to generate holographic content.

The image from the tracking system 580 is encoded to a convolutional layer A. Images input in the convolutional layer A can be related to various characteristics and/or reaction information, etc. in the identification layer C. Relevance information between these elements can be retrieved by applying a set of transformations between the corresponding layers. That is, a convolutional layer A of an AI model represents an encoded image, and identification layer C of the model represents a smiling viewer. Smiling viewers in a given image may be identified by applying the transformations W₁ and W₂ to the pixel values of the image in the space of convolutional layer A. The weights and parameters for the transformations may indicate relationships between information contained in the image and the identification of a smiling viewer. For example, the weights and parameters can be a quantization of shapes, colors, sizes, etc. included in information representing a smiling viewer in an image. The weights and parameters may be based on historical data (e.g., previously tracked viewers).

Smiling viewers in the image are identified in the identification layer C. The identification layer C represents identified smiling viewers based on the latent information about smiling viewers in the image.

Identified smiling viewers in an image can be used to generate holographic content. To generate holographic content, the AI model starts at the identification layer C and applies the transformations W₂ and W₃ to the value of the given identified smiling viewers in the identification layer C. The transformations result in a set of nodes in the output layer E. The weights and parameters for the transformations may indicate relationships between an identified smiling viewers and specific holographic content and/or preferences. In some cases, the holographic content is directly output from the nodes of the output layer E, while in other cases the content generation system decodes the nodes of the output layer E into a holographic content. For example, if the output is a set of identified characteristics, the LF processing engine 530 can use the characteristics to generate holographic content.

Additionally, the AI model can include layers known as intermediate layers. Intermediate layers are those that do not correspond to an image, identifying characteristics/reactions, etc., or generating holographic content. For example, in the given example, layer B is an intermediate layer between the convolutional layer A and the identification layer C. Layer D is an intermediate layer between the identification layer C and the output layer E. Hidden layers are latent representations of different aspects of identification that are not observed in the data, but may govern the relationships between the elements of an image when identifying characteristics and generating holographic content. For example, a node in the hidden layer may have strong connections (e.g., large weight values) to input values and identification values that share the commonality of “laughing people smile.” As another example, another node in the hidden layer may have strong connections to input values and identification values that share the commonality of “scared people scream.” Of course, any number of linkages are present in a neural network. Additionally, each intermediate layer is a combination of functions such as, for example, residual blocks, convolutional layers, pooling operations, skip connections, concatenations, etc. Any number of intermediate layers B can function to reduce the convolutional layer to the identification layer and any number of intermediate layers D can function to increase the identification layer to the output layer.

In one embodiment, the AI model includes deterministic methods that have been trained with reinforcement learning (thereby creating a reinforcement learning model). The model is trained to increase the quality of the performance using measurements from tracking system 580 as inputs, and changes to the created holographic content as outputs.

Reinforcement learning is a machine learning system in which a machine learns ‘what to do’—how to map situations to actions—so as to maximize a numerical reward signal. The learner (e.g. LF processing engine 530) is not told which actions to take (e.g., generating prescribed holographic content), but instead discovers which actions yield the most reward (e.g., increasing the quality of holographic content by making more people cheer) by trying them. In some cases, actions may affect not only the immediate reward but also the next situation and, through that, all subsequent rewards. These two characteristics—trial-and-error search and delayed reward—are two distinguishing features of reinforcement learning.

Reinforcement learning is defined not by characterizing learning methods, but by characterizing a learning problem. Basically, a reinforcement learning system captures those important aspects of the problem facing a learning agent interacting with its environment to achieve a goal. That is, in the example of generating a song for a performer, the reinforcement learning system captures information about viewers in the venue (e.g., age, disposition, etc.). Such an agent senses the state of the environment and takes actions that affect the state to achieve a goal or goals (e.g., creating a pop song for which the viewers will cheer). In its most basic form, the formulation of reinforcement learning includes three aspects for the learner: sensation, action, and goal. Continuing with the song example, the LF processing engine 530 senses the state of the environment with sensors of the tracking system 580, displays holographic content to the viewers in the environment, and achieves a goal that is a measure of the viewer's reception of that song.

One of the challenges that arises in reinforcement learning is the trade-off between exploration and exploitation. To increase the reward in the system, a reinforcement learning agent prefers actions that it has tried in the past and found to be effective in producing reward. However, to discover actions that produce reward, the learning agent selects actions that it has not selected before. The agent ‘exploits’ information that it already knows in order to obtain a reward, but it also ‘explores’ information in order to make better action selections in the future. The learning agent tries a variety of actions and progressively favors those that appear to be best while still attempting new actions. On a stochastic task, each action is generally tried many times to gain a reliable estimate to its expected reward. For example, if the LF processing engine creates holographic content that the LF processing engine knows leads to a viewer laughing performance after a long period of time, the LF processing engine may change the holographic content such that the time until a viewer laughs decreases.

Further, reinforcement learning considers the whole problem of a goal-directed agent interacting with an uncertain environment. Reinforcement learning agents have explicit goals, can sense aspects of their environments, and can choose actions to receive high rewards (i.e., a roaring crowd). Moreover, agents generally operate despite significant uncertainty about the environment it faces. When reinforcement learning involves planning, the system addresses the interplay between planning and real-time action selection, as well as the question of how environmental elements are acquired and improved. For reinforcement learning to make progress, important sub problems have to be isolated and studied, the sub problems playing clear roles in complete, interactive, goal-seeking agents.

The reinforcement learning problem is a framing of a machine learning problem where interactions are processed and actions are carried out to achieve a goal. The learner and decision-maker is called the agent (e.g., LF processing engine 530). The thing it interacts with, comprising everything outside the agent, is called the environment (e.g., viewers in a venue, etc.). These two interact continually, the agent selecting actions (e.g., creating holographic content) and the environment responding to those actions and presenting new situations to the agent. The environment also gives rise to rewards, special numerical values that the agent tries to maximize over time. In one context, the rewards act to maximize viewer positive reactions to holographic content. A complete specification of an environment defines a task which is one instance of the reinforcement learning problem.

To provide more context, an agent (e.g., content generation system 350) and environment interact at each of a sequence of discrete time steps, i.e. t=0, 1, 2, 3, etc. At each time step t the agent receives some representation of the environment's state st (e.g., measurements from tracking system 580). The states st are within S, where S is the set of possible states. Based on the state sₜ and the time step t, the agent selects an action at (e.g., making the performer do the splits). The action at is within A(sₜ), where A(sₜ) is the set of possible actions. One time state later, in part as a consequence of its action, the agent receives a numerical reward rₜ₊₁. The states rₜ₊₁ are within R, where R is the set of possible rewards. Once the agent receives the reward, the agent selects in a new state sₜ₊₁.

At each time step, the agent implements a mapping from states to probabilities of selecting each possible action. This mapping is called the agent's policy and is denoted πₜ where πₜ(s,a) is the probability that aₜ=a if sₜ=s. Reinforcement learning methods can dictate how the agent changes its policy as a result of the states and rewards resulting from agent actions. The agent's goal is to maximize the total amount of reward it receives over time.

This reinforcement learning framework is flexible and can be applied to many different problems in many different ways (e.g. generating holographic content). The framework proposes that whatever the details of the sensory, memory, and control apparatus, any problem (or objective) of learning goal-directed behavior can be reduced to three signals passing back and forth between an agent and its environment: one signal to represent the choices made by the agent (the actions), one signal to represent the basis on which the choices are made (the states), and one signal to define the agent's goal (the rewards).

Of course, the AI model can include any number of machine learning algorithms. Some other AI models that can be employed are linear and/or logistic regression, classification and regression trees, k-means clustering, vector quantization, etc. Whatever the case, generally, the LF processing engine 530 takes an input from the tracking module 526 and/or viewer profiling module 528 and a machine learning model creates holographic content in response. Similarly, the AI model may direct the rendering of holographic content.

The preceding examples of creating content are not limiting. Most broadly, LF processing engine 530 creates holographic content for display to viewers of a LF display system 500. The holographic content can be created based on any of the information included in the LF display system 500.

The vehicle interface 532 provides instructions to the vehicle based on user interactions with holographic content. The vehicle interface 532 monitors interactions with holographic content and identifies instructions to provide to the vehicle based on the monitored interactions. The vehicle interface 532 apply, e.g., a look up table (LUT), machine learning, neural networks, or some combination thereof, to tracking information and generated holographic content to determine whether a user is interacting with the holographic content. For example, the vehicle interface 532 monitors a user interacting with a holographic object corresponding to a holographic drive button of a shifter. As the user pushes the holographic drive button (as described above), the vehicle interface 532 determines (e.g., via machine learning) that the user is intending to put the vehicle into drive, and instructs the vehicle to put its transmission into drive. In another example, the vehicle interface 532 may monitor a user interacting with a holographic object that corresponds to a steering wheel. As the user rotates the holographic object in a particular direction, the vehicle interface 532 determines (e.g., via machine learning) that the user is intending to turn the vehicle in the particular direction and instructs the vehicle to turn in the particular direction.

In some embodiments, the vehicle interface 532 interfaces with a self-driving function of a vehicle. A self-driving function is a process by which the vehicle drives itself with little or no human intervention. For example, a vehicle occupant may provide a destination address via the LF display system 500, from which the vehicle would then automatically drive the vehicle to the destination address. One skilled in the art of self-driving vehicles could implement such a self-driving function in a vehicle. In some embodiments, the LF display system may present a holographic driver to one or more occupants of a self-driving vehicle. The holographic driver may be, e.g., an image of a person that one or more of the vehicles occupants could interact with. The LF display system 500 may receive inputs (e.g., the destination address) from an occupant as he/she interacts with the holographic driver. The LF display system 500 may dynamically update the holographic driver (e.g., having the holographic driver look at the occupant speaking to it) and/or other holographic content that is being presented to the occupants. The LF display system 500 may provide one or more inputs from the occupants to the self-driving function of the vehicle.

FIG. 6A is a perspective view of a vehicle 600 augmented with a LF display system, in accordance with one or more embodiments. In the illustrated embodiment, the vehicle 600 is an automobile. In other embodiments, the vehicle 600 is some other type of machine used to transport people, goods, sensor equipment, and/or weapons. The vehicle 600 may be, e.g., an automobile (e.g., car, truck, etc.), a plane, a drone, an un-manned aerial vehicle, a tank, a boat, a submarine, some other machine used for transport, or some combination thereof. The LF display system is an embodiment of the LF display system 500.

In the illustrated embodiment, the LF display system includes a plurality of LF display modules that are part of a portion of an exterior surface of the vehicle 600. Each LF display module is shown as a dashed polygon. Note that in practice, a size of the LF display module, a number of the LF display modules, a location of the LF display module, or some combination thereof, may be different than what is shown. The LF display modules may be tiled to form a seamless display surface across some or all of the exterior surface of the vehicle. The exterior surface of the vehicle is a surface of a vehicle that is visible to a viewer who is outside of the vehicle. The exterior surface may include, e.g., windows, vehicle body, vehicle wheel covers, some other portion of an exterior surface, or some combination thereof. For example, the vehicle 600 includes a plurality of LF display modules (e.g., the LF display module 610) on the vehicle body, a plurality of LF display modules (e.g., the LF display module 620) on the vehicle wheel covers, and a plurality of LF display modules (e.g., the LF display module 630) on the windows. Note that in some embodiments, the LF display modules on the windows may be transparent to visible light.

The LF display modules along the exterior surface are configured to project holographic content to change an appearance of the vehicle 600. In this manner, a user of LF display system (e.g., vehicle operator, vehicle manufacturer) can modify how the vehicle appears to viewers outside of the vehicle. For example, the LF display system may change the texture, color, and features of some or all of the vehicle and/or project decorative objects. In the case of a bus, the LF display system may act as a billboard to project holographic objects behind the display surface as well as floating in front of the display surface to catch the attention of pedestrians on the sidewalk. In the case of a tank, the LF display system may act to project shrubs and foliage (which may be real images) to camouflage the vehicle by blending it in with its surroundings. In another embodiment, light field cameras the right side of the vehicle, opposite to 630, may capture images which are projected on the left side of the vehicle on displays 610, 620, and 630 to make the vehicle appear transparent to a bystander outside of the vehicle and located on the left side of the vehicle who is viewing the vehicle.

FIG. 6B is a perspective view of the vehicle 600 of FIG. 6A presenting holographic content, in accordance with one or more embodiments. The LF display modules project holographic objects at a plurality of configurable physical locations relative to display surfaces of the LF display modules. In the illustrated embodiment, the LF display system of the vehicle 600 is presenting holographic content such that an appearance of the vehicle 600 is changed. For example, the LF display system is presenting a holographic objects 640, 650, 660, and 670 at respective configurable physical locations. The holographic objects 640 and 650 appear as a decorative rear turn signalers that project out of the LF display module 610. The holographic objects 640, 650 appear outside of the LF display modules in a holographic object volume of the LF display system at certain vantage points. In some embodiments, ultrasonic speakers within the LF display modules may be used to generate a haptic surface that coincides with at least a portion of holographic objects. For example, the ultrasonic speakers can generate a haptic surface that coincides with an outer surface of the holographic object 650.

The holographic object 660 is an image that appears as a pinstripe along the exterior surface of the vehicle 600. The holographic object 670 changes a color of some of the exterior surface of the vehicle 600. Note that the illustrated holographic object 640, holographic object 650, holographic object 660, and holographic object 670 are merely examples, and that in other embodiments other holographic objects (e.g., decorative fins, brake lights that project out from the vehicle 600, etc.) may be presented by the LF display system, and they may be presented at other physical locations.

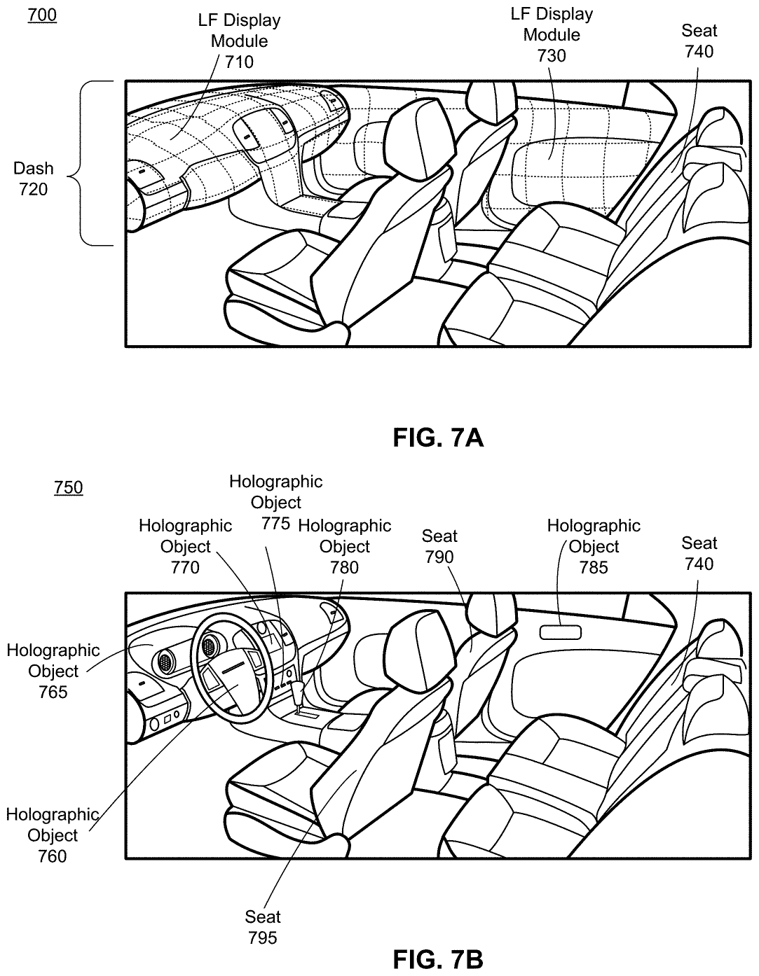

FIG. 7A is a perspective view of an interior 700 of a vehicle augmented with a LF display system, in accordance with one or more embodiments. In the illustrated embodiment, the vehicle is an automobile. In other embodiments, the vehicle is some other type of machine used to transport people, goods, sensor equipment, and/or weapons. The vehicle may be, e.g., an automobile, a plane, a drone, an un-manned aerial vehicle, a tank, a boat, a submarine, some other machine used for transport, or some combination thereof. In some embodiments, the vehicle is the vehicle 600. The LF display system is an embodiment of the LF display system 500.

The LF display system includes a LF display assembly. The LF display assembly includes at least one LF display module mounted on an internal surface of the interior 700 of the vehicle. The at least one LF display module is configured to present one or more holographic objects at a plurality of locations relative to a display surface of the at least one LF display module. The locations include locations between the display surface and a viewing volume of the at least one display surface.

In the illustrated embodiment, the LF display system includes a plurality of LF display modules that are part of an interior surface of the vehicle. Each LF display module is shown as a dashed polygon. Note that in practice, a size of the LF display module, a number of the LF display modules, a location of the LF display module, or some combination thereof, may be different than what is shown. The LF display modules may be tiled to form a seamless display surface across some or all of the interior 700. In some embodiments, the LF display modules are formed into panels that are specific to different locations of the interior. The interior surface of the vehicle is a surface of a vehicle that is within the interior 700 of the vehicle. The interior surface may include, e.g., windows, seats, door panels, roof, dash, floor, some other portion of the interior 700, or some combination thereof.

For example, the vehicle includes a plurality of LF display modules (e.g., the LF display module 710) on a dash 720 and a plurality of LF display modules (e.g., the LF display module 730) on door panels. The LF display modules along the interior surface are configured to project holographic content to change an appearance of portions of the interior 700. In this manner, a user of LF display system can modify how the vehicle appears to it users. For example, the holographic content may include, e.g., a steering control interface (e.g., steering wheel), instrument cluster (e.g., speedometer, tachometer, etc.), a music control interface (e.g., radio, music player), climate control interface (heater and/or air conditioning controls), windows control interfaces (e.g., to control opening/closing of the windows), door control interfaces (e.g., allow locking/unlocking of the door and/or opening of the door), a mapping control interface (also referred to as a navigation control interface), a computer interface (e.g., make calls or interface with a phone that makes calls), a shifter interface (e.g., corresponding to a manual or automatic transmission), some other control interface for the vehicle, or some combination thereof. Note that some or all of the holographic content may include haptic buttons, knobs, levers, or some other type of interface, by which a user can interact with the holographic content. Moreover, the LF display system may display holographic content that are customized to one or more users of the vehicle. For example, holographic content (e.g., instrument cluster, etc.) presented by the LF display module 710 may be customized to the driver, whereas a window control interface presented by the LF display module 730 is customized to a user of a seat 740.

FIG. 7B is a perspective view 750 of the interior 700 of FIG. 7A presenting holographic content, in accordance with one or more embodiments. In the illustrated embodiment, the LF display system of the vehicle is presenting holographic content such that an appearance of the interior 700 is changed. For example, the LF display system is presenting a holographic object 760, a holographic object 765, holographic object 770, holographic object 775, holographic object 780, and holographic object 785. Note that the illustrated holographic object 760, holographic object 765, holographic object 770, holographic object 775, holographic object 780, and holographic object 785 are merely examples, and that in other embodiments other holographic content and/or holographic objects may be presented by the LF display system. For example, the configuration of the holographic content presented within the interior 700 is based in part on the viewer profiles of the vehicle's occupants. For example, a viewer profile of a driver may indicate that the driver prefers to drive an automatic versus a manual transmission, and the LF display system would render the shifter as a holographic automatic shifter. In a similar manner, viewer profiles for passengers of the vehicle may be used to customize layout, color, etc. of holographic content to the passenger.

In FIG. 7B, the holographic object 760 appears as a steering wheel (e.g., a type of steering interface controller). The holographic object 765 is a real image of an instrument cluster. The holographic object 770 may be, e.g., a music control interface, a mapping control interface, a communication interface (e.g., to make a wireless call), a computer control interface, or some combination thereof. The holographic object 780 is a real image of a shifter. The holographic object 785 is a real image of a window control interface and/or door control interface.

In some embodiments, the light field display modules 710 and 730 may be dual energy projection devices which project volumetric haptic surfaces using ultrasonic pressure waves, which can be used to generate haptic surfaces. As an example, these haptic surfaces may feel like controls with textures that that coincide with at least a portion of projected holographic controls. For example, the ultrasonic speakers can generate a haptic surface that coincides with an outer surface of the holographic object 760.

The LF display system may also include one or more cameras that are part of a tracking system to generate tracking information that describes movement of a user of the vehicle. These cameras may be internal to the light field display assembly, 510, or exist external to 510 as separate cameras. The LF display system can use the tracking information to monitor hand pose and/or location relative to holographic content (including holographic objects) within the interior 700. For example, the holographic object 770 may include a real image of a button. The LF display system can project ultrasonic energy to generate a tactile surface that corresponds to the holographic object 770 and occupies substantially the same space as some or all of an exterior surface of that object (i.e., a button). The LF display system can use the tracking information to dynamically move the location of the tactile surface along with dynamically moving the button as it is “pushed” by the user. The LF display system provides instructions to the vehicle based on the tracked information. For example, responsive to tracking information indicating that the user has “pushed” the button, the LF display system may instruct the vehicle to turn on navigation or lock the doors. In a similar manner, the LF display system can use tracking information to provide instructions to the vehicle as a user interacts with other holographic content (e.g., instrument cluster, a music control interface, windows control interfaces, door control interfaces, etc.). Moreover, in some embodiments, some users can interact with holographic content while others cannot. For example, in a law enforcement vehicle it may be beneficial to not allow passengers in the back seat to have access to the door controls (e.g., the holographic object 785).

In some embodiments, responsive to a user input, the LF display system may adjust one or more of, an operating state of the vehicle (e.g., engine on/off, active gear, drive configuration, etc.), an interior configuration of the vehicle, at least one of the one or more holographic objects, an arrangement of the one or more holographic objects, or some combination thereof.

One potential advantage of augmenting the interior 700 with holographic content is that it allows for dynamic customization of the interior 700 of the vehicle. An interior configuration of the vehicle refers to holographic content that describes the interior 700 of the vehicle. For example, the driver can customize the interior configuration by adjusting what instruments they would like to see in the instrument cluster (e.g., holographic object 765), where the steering wheel is located (e.g., holographic object 760), whether the vehicle presents as automatic or a manual transmission (e.g., via the holographic object 780), a location of a window control interface, a location of a door control interface, etc. Moreover, in some embodiments, the actual location of the driver can be in either seat 790 or 795. Note that the vehicle controls are holographic content. Accordingly, in addition to the embodiment shown in FIG. 7B, the LF display system (e.g., via the LF display module 710) in an alternate embodiment, the holographic object 760 and the holographic object 765 are rendered in front of seat 790 and not in seat 795. Likewise, other holographic content (e.g., the holographic object 780) may be adjusted for a driver that is positioned in seat 790.

In some embodiments, the LF display system may present one or more holographic objects that are customized to each user based in part on the tracking information. In this manner, viewers that are at least a threshold distance from each other (e.g., a couple feet) are able to see completely different holographic content. For example, the LF display system tracks a position (e.g., eye position) of a driver and position (e.g., eye positions) of passengers within the vehicle, and determines perspectives of holographic content (e.g., holographic objects) that should be visible to occupants of the vehicle based on their tracked positions relative to where the holographic objects would be presented. The LF display system selectively emits light from specific pixels of the LF display modules toward the tracked eye positions, the specific pixels corresponding to the determined perspectives. Accordingly, different viewers can simultaneously be presented with completely different holographic content. For example, the LF display modules may present a door panel as being red leather, and simultaneously present a different passenger with holographic content indicating that the door panel is white canvas. And either passenger would not be able to perceive the content the other passenger was being presented.

In some embodiments, the LF display system may present one or more holographic objects that relate to navigation and/or mapping. For example, holographic objects may include: a navigation screen which shows information about the vehicle's location, navigation aids, navigation directional indicators, navigational information, suggested vehicle routes, images associated with the vehicle surroundings, navigational content projected in front of the driver to help the driver keep focus on the road, navigational or informational content overlaid onto actual objects in the vicinity of the vehicle, or some combination thereof. In some embodiments, these holographic objects may be presented as part of holographic heads-up display.

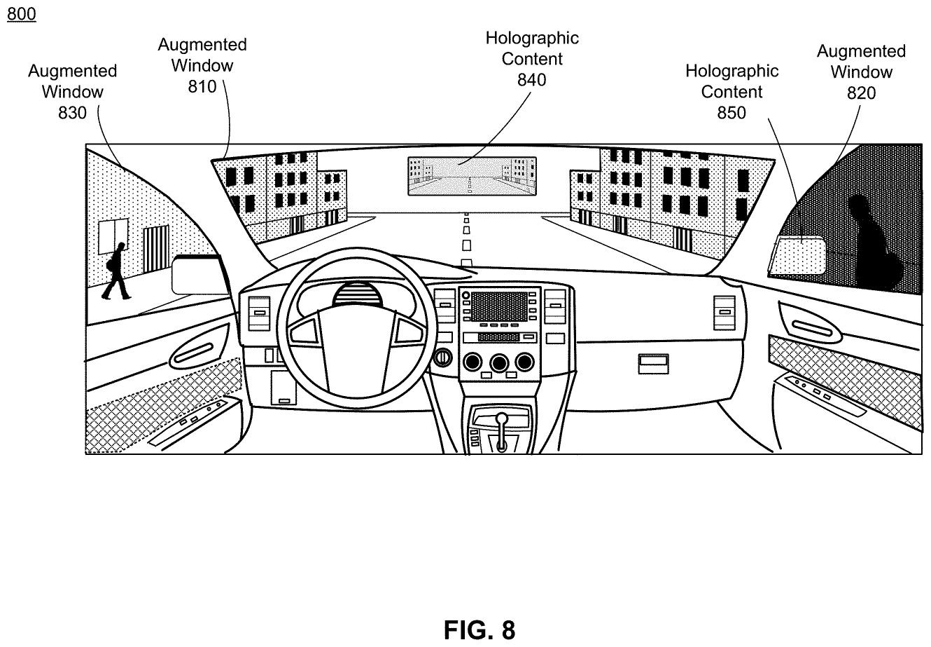

FIG. 8 is a perspective view 800 of an interior of a vehicle augmented with a LF display system including augmented windows, in accordance with one or more embodiments. In the illustrated embodiment, the vehicle is an automobile. In other embodiments, the vehicle is some other type of machine used to transport people, goods, sensor equipment, and/or weapons. The vehicle may be, e.g., an automobile, a plane, a drone, an un-manned aerial vehicle, a tank, a boat, a submarine, some other machine used for transport, or some combination thereof. In some embodiments, the vehicle is the vehicle 600. The LF display system is an embodiment of the LF display system 500.

In the illustrated embodiment, the LF display system includes an augmented window 810, an augmented window 820, and an augmented side window 830. In other embodiments, the LF display system may include more or less augmented windows. An augmented window is a window that includes at least some LF display modules, shows views of the outside of the vehicle from the inside of the vehicle, and is able to modify those views or superimpose other content onto those views. As an example, this can be done for the purpose of navigation, entertainment, or environmental control. Augmented windows may overlay outside views captured by one or more 2D or light field cameras with 2D or 3D navigation aids projected far in front of the driver so that the driver does not have to refocus to the console repeatedly while being guided by the navigation aids. In another embodiment, the augmented windows can show holographic objects to the passengers to show them tourist features. And the augmented windows may tint the windows in order to achieve a comfortable level of light, for environmental control. In the illustrated embodiments, the LF display modules (not shown) span each of the augmented window 810, the augmented window 820, and the augmented window 830. In other embodiments, the LF display modules of at least one of the augmented window form a portion of the augmented window and at least some of the remaining portion includes a material transparent to visible light (e.g., tempered glass).

The LF display modules that form some or all of the augmented windows (e.g., 810, 820, and 830) of a vehicle may be able to adjust tint, either by dynamically attenuating visible light according to some programming, or in accordance with instructions from a user (e.g., a driver and/or passenger). The LF display modules may tint some or all of the augmented windows in accordance with a viewer profile of an occupant of the vehicle. In some embodiments, a level of attenuation may be different for one or more windows. For example, as illustrated in FIG. 8, the augmented window 820 has more tint than the augmented window 810 and the augmented window 830.

The LF display modules of an augmented window may present holographic content. For example, in FIG. 8, the augmented window 810 presents holographic content 840, and the augmented window 820 presents holographic content 850. The holographic content 840 and/or the holographic content 850 can include one or more holographic objects that are captured images or augmented captured images from outside the vehicle. In one embodiment, the holographic content 840 functions as a holographic rear-view mirror. In this embodiment, there may be one or more 2D cameras positioned to capture images of a local area behind the vehicle, and the holographic content 840 may show this view as a 2D image in a viewing plane that is projected comfortably in front of the driver when the driver is operating the vehicle in reverse. The LF display system may include one or more cameras (e.g., within one or more LF display modules) that are positioned to capture images of a local area behind the vehicle). In another embodiment, there may be one or more light field cameras positioned behind the vehicle, and the holographic content 840 may show this view as a holographic image in front of the driver. The images are rendered within the holographic object volume of the augmented window 810. Accordingly, the images may be rendered as part of a holographic object in real space (e.g., between the augmented window 810 and a passenger of the vehicle), as part of a holographic object in the plane of the LF display modules, as part of a holographic object behind and/or beyond the plane of the augmented window 810, or some combination thereof. In a similar manner, the holographic content 850 may be rendered. For example, captured images of a portion of the local area may be rendered as part of a holographic object in front of 820 (e.g., between the augmented window 820 and a passenger of the vehicle), as part of a holographic object in the plane of the LF display modules that make up the augmented window 820, as part of a holographic object beyond the plane of the augmented window 820, or some combination thereof.

Note that an augmented window (and more generally a LF display module and/or a plurality of LF display modules that are tiled together) can function as a window. It is important to note that this differs from simply presenting an image from a camera on an electronic display. In electronic display case, the presented image is static and does not change based on location of a viewer. In contrast, a holographic object presented behind a display surface of an augmented window supports full parallax (e.g., recreates ray bundles of light at the surface of the holographic objects identical to physical rays, etc.), such that the holographic object changes based on position of the viewer relative to the holographic object.

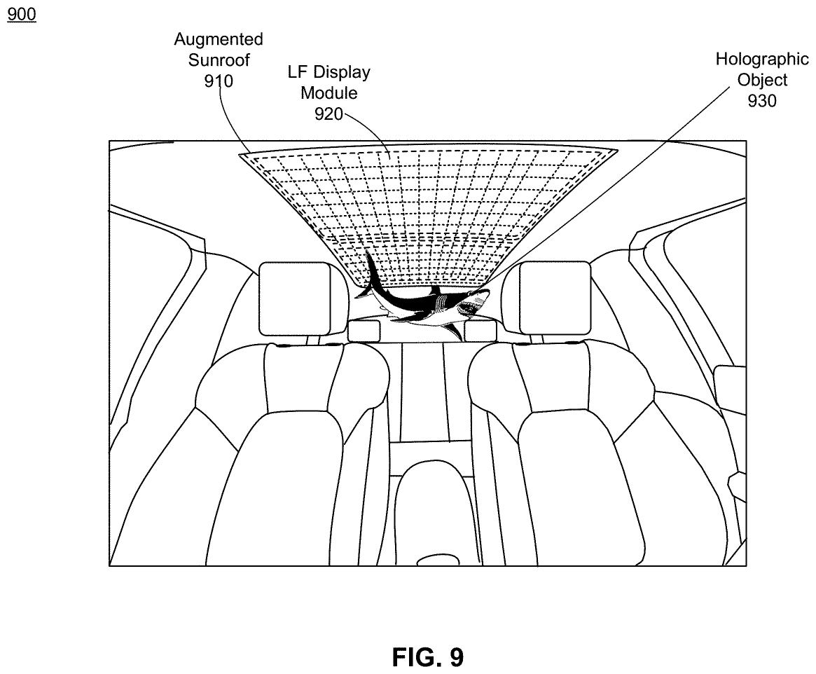

FIG. 9 is a perspective view 900 of an interior of a vehicle augmented with a LF display system including an augmented sunroof 910, in accordance with one or more embodiments. In the illustrated embodiment, the vehicle is an automobile. In other embodiments, the vehicle is some other type of machine used to transport people, goods, sensor equipment, and/or weapons. The vehicle may be, e.g., an automobile, a plane, a drone, an un-manned aerial vehicle, a tank, a boat, a submarine, some other machine used for transport, or some combination thereof. In some embodiments, the vehicle is the vehicle 600. The LF display system is an embodiment of the LF display system 500.

In the illustrated embodiment, the LF display system includes an augmented sunroof 910. An augmented sunroof is an augmented window as described above with reference to FIG. 8 that is located along a roof of the interior of the vehicle. The augmented sunroof 910 is a window that includes at least some LF display modules (e.g., a LF display module 920). In the illustrated embodiment, the LF display modules span (in a tiled manner to form a seamless display surface) the augmented sunroof 910. In other embodiments, the LF display modules of form a portion of the augmented sunroof 910 and at least some of the remaining portion includes a material transparent to visible light (e.g., tempered glass).

The augmented sunroof 910 presents holographic content to users (e.g., passengers) of the vehicle. The LF display system may include one or more cameras (e.g., as part of the LF display modules, or external to the LF display modules) that are configured to capture images of a local area above the vehicle. The LF display system may use generate and update holographic content presented by the augmented sunroof 910 based in part on the captured images. In some embodiments, the augmented sunroof 910 presents holographic content in accordance with a viewer profile of at least one of the occupants of the vehicle.

The augmented sunroof 910 presents holographic content within a holographic object volume of the augmented sunroof 910. As illustrated in FIG. 9, the augmented sunroof 910 is presenting a holographic object 930, and the holographic object 930 is a shark. The holographic object 930 may be presented anywhere within a holographic object volume of a display surface of the augmented sunroof 910. And as discussed above with regard to, e.g., FIG. 2A the holographic object volume includes a region between the display surface and a user as well as a region behind the display surface. A user within a viewing volume of the augmented sunroof 910 may move to other locations relative to the holographic object 930 to see different views of the shark. Moreover, different users viewing the shark from different locations would see different perspectives of the shark. For example, a user to the left of the shark would see one side of the shark, and a user to the right of the shark would see the other side of the shark. In some embodiments, the holographic object 930 is visible to all users within a viewing volume of the augmented sunroof 910 that have an unobstructed line (i.e., not blocked by an object/person) of sight to the holographic object 930. These users may be unconstrained such that they can move around within the viewing volume to see different perspectives of the holographic object 930. Accordingly, the LF display system may present holographic objects such that a plurality of unconstrained users may simultaneously see different perspectives of the holographic objects in real-world space as if the holographic objects were physically present.

In some embodiments, one or more LF display systems may be used to generate a tactile surface that is coincident with a surface of the holographic object 930 such that users may touch the holographic object 930; and (2) provide audio content corresponding to presented holographic object. The light field display assembly may include acoustic emitters and a dual energy surface that includes a volumetric haptic projection system, resulting in tactile surfaces being projected. In another embodiment, external haptic projection systems may be used to project tactile surfaces. Moreover, similar to FIGS. 7A, 7B, and 8, the LF display modules of the augmented sunroof 910 and/or other LF display modules may include one or more cameras that are part of a tracking system to generate tracking information that describes movement of a user of the vehicle. The LF display system can use the tracking information to monitor hand pose and/or location relative to holographic content (including holographic objects) within the interior 700. For example, a user may attempt touch the holographic object 930 as if it was a physical shark. The LF display system can use the tracking information to dynamically move the location of the tactile surface along with dynamically moving the shark as it is “touched” by the user.

In some embodiments, the LF display system may present one or more holographic objects that are customized to each viewer based in part on the tracking information. In this manner, viewers that are at least a threshold distance from each other (e.g., a couple feet) are able to see completely different holographic content. For example, the LF display system tracks a position (e.g., eye position) of a driver and positions (e.g., eye positions) of passengers within the vehicle, and determines perspectives of holographic objects that should be visible to occupants of the vehicle based on their tracked positions relative to where the holographic objects would be presented. The LF display system selectively emits light from specific pixels of the LF display modules (e.g., of the augmented sunroof 910) to the tracked eye positions, the specific pixels corresponding to the determined perspectives. Accordingly, different viewers can simultaneously be presented with completely different holographic content. For example, the augmented sunroof 910 and/or other LF display modules may present a passenger with holographic content that is space related, and simultaneously present a different passenger with holographic content that is ocean related. And either passenger would not be able to perceive the content the other passenger was being presented. In another example, the augmented sunroof 910 and/or other LF display modules may present holographic content to the passengers, but not present the holographic content to the driver (e.g., the holographic object 930 is visible to a passenger over a time period while not being visible to the driver over the same time period). The LF display system may also merely present content that is unique for each seating position within the vehicle, without the need for occupant tracking. In another embodiment, holographic objects showing tourist features visible outside each window can be projected to the passengers in the seat closest to the window.

Note that the augmented sunroof 910 is an augmented window and can function as a window. And as discussed above with regard to FIG. 8, that this differs from simply presenting an image from a camera on an electronic display. In the electronic display case, the presented image is static and does not change based on location of a viewer. In contrast, a holographic object presented behind a display surface of the augmented sunroof 910 supports full parallax (e.g., recreates ray bundles of light at the surface of the holographic objects identical to physical rays, etc.), such that the holographic object changes based on position of the viewer relative to the holographic object.

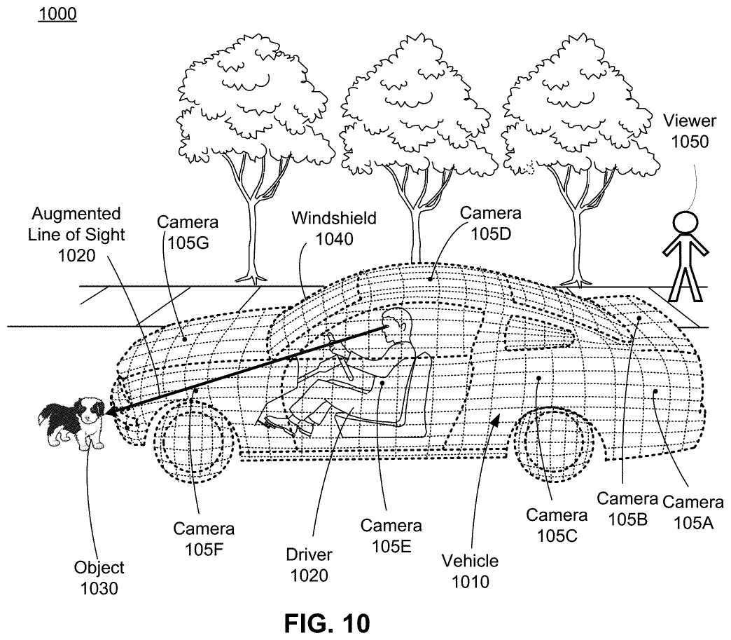

FIG. 10 is a perspective view 1000 of a vehicle 1010 augmented with a LF display system to mitigate blind spots, in accordance with one or more embodiments. In the illustrated embodiment, the vehicle 1010 is an automobile. In other embodiments, the vehicle 1010 is some other type of machine used to transport people, goods, sensor equipment, and/or weapons. The vehicle 1010 may be, e.g., an automobile, a plane, a drone, an un-manned aerial vehicle, a tank, a boat, a submarine, some other machine used for transport, or some combination thereof. The LF display system is an embodiment of the LF display system 500.

In the illustrated embodiment, the LF display system includes a plurality cameras that are part of a portion of an exterior surface of the vehicle 1010 (e.g., as described above with regard to FIGS. 6A-6B) and LF display modules that are part of an interior surface of the vehicle 1010 (e.g., as described above with regard to FIGS. 7A-B). In FIG. 10, some, but not all of the cameras are visible (e.g., cameras 105A-G). Additionally, in some embodiments, more or less cameras may be used (e.g., in some cases there is a single camera). Preferably the cameras together have a field of view that surrounds all sides of the vehicle, and may also include portions of the local area above and/or below the vehicle 1010. As illustrated, there are no LF display modules along the exterior surface of the vehicle 1010. In some embodiments (not shown), the cameras are part of LF display modules along the exterior of the vehicle 1010. And the LF display modules may be tiled to form a seamless display surface across some or all of the exterior surface of the vehicle 1010. Additionally, the interior of the vehicle 1010 includes a plurality of LF display modules that may be tiled to form a seamless display surface across some or all of the interior surface of the vehicle 1010.

The vehicle 1010 includes cameras that capture images of a local area surrounding the vehicle 1010. The LF display system uses the captured images to generate holographic content that is then presented to a driver 1020 of the vehicle 1010 using the LF display modules along the interior of the vehicle 1010. The LF display modules along the interior of the vehicle present holographic content that correspond to the captured images. The LF display system presents the generated holographic content to the driver 1020 such that at least a portion of the vehicle between the driver 1020 and the blind spot appears to be transparent. For example, if the captured image includes an object 1030, which as illustrated is a dog, the holographic content includes a holographic object that is located where the object 1030 is located and moves with the object 1030. Moreover, the holographic object can be rendered to appear as the dog or some other object (e.g., a dog overlaid in blinking red to alert the driver 1020 to the object 1030 in the blind spot). The holographic content can be a holographic scene if the capture cameras outside the vehicle are light field cameras, or a 2D view of the scene projected a distance from the driver if the capture cameras outside the vehicle are not light field cameras. The view of the outside can be augmented with blinking red alerts, flashing lights, or any other indicator.

In this manner, the LF system is able to greatly increase a field of view for the driver 1020, and potentially other passengers as well. The LF display system increases the field of view by turning some or all of the vehicle 1010 substantially transparent from the perspective of the driver 1020 (and/or passengers). The LF display system thereby gives an experience of “looking” through portions of the vehicle that are not transparent to visible light to the driver 1020 and/or other passengers. Note that this is different from simply displaying on a screen. The holographic content is presented such that it appears at a same depth as the corresponding physical object (e.g., similar to a user looking through a window and seeing objects on the other side of the window). For example, the object 1030 is located in a blind spot for the driver 1020. A blind spot is a location that is outside of a field of view of the driver 1020 as they look through a windshield 1040 and/or other windows of the vehicle 1010. As described above, the LF display system enlarges the field of view of the driver 1020 such that the field of view include an augmented line of sight to the object 1030. In a similar manner, the driver 1020 is able to look around and see holographic content corresponding to other blind spots. This alleviates the need for backup cameras, etc., as the LF display system presents holographic content to the driver 1020 that simulates looking “through” the vehicle 1010 to see objects in the local area.

In some embodiments, the LF display system may overlay a wireframe of some or all of a body of the vehicle 1010 to assist the driver 1020 in knowing where the vehicle 1010 is relative to objects in the local area surrounding the vehicle 1010.

The captured images may include images of some or all of the local area surrounding the vehicle 1010. In some embodiments, the LF display system uses the captured images of the local area to generate holographic content that is then presented to viewers (e.g., a viewer 1050) external to the vehicle 1010 using LF display modules along the exterior of the vehicle 1010. For example, the LF display system may make the automobile appear transparent such that a viewer 1050 could look through the automobile to see the object 1030. For example, the LF display system may determine a rendering perspective for the viewer 1050 within a viewing volume of the LF display modules along a first side of the vehicle 1010 based on the captured images of the portion of the local area including the object 1030. The LF display system generates holographic content based in part on the determined rendering perspective. The LF display system presents the generated holographic content to the viewer 1040 such that at least a portion of the vehicle appears to be transparent.

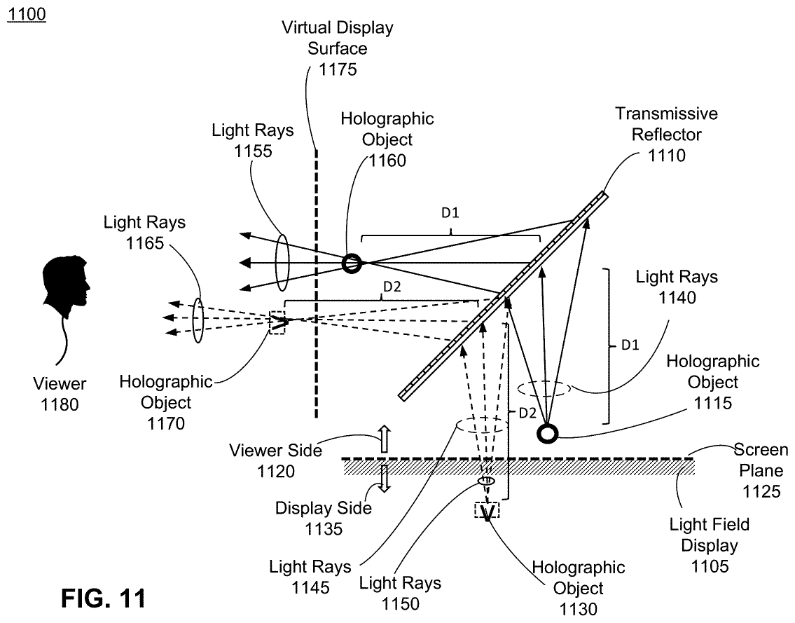

FIG. 11 illustrates an example system 1100 that relays the holographic object volume projected by a light field display 1105 using a transmissive reflector 1110, in accordance with one or more embodiments.

In some embodiments, the transmissive reflector 1110 is a dihedral corner reflector array (DCRA). A DCRA is an optical imaging element composed of a plurality of dihedral corner reflectors. In some embodiments, the DCRA is formed using two thin layers of closely-spaced parallel mirror planes, oriented so the planes are orthogonal to one another. In other embodiments, the transmissive reflector 1110 is an array of corner reflector micro mirrors.

The function of the transmissive reflector may be achieved with the use of a beamsplitter and a retroreflector. The beamsplitter is disposed in a similar orientation to the transmissive reflector 1110 in FIG. 11, and the retroreflector is placed to the left of the transmissive reflector 1110 in FIG. 11, with the plane of the retroreflector normal to the screen plane 1125. In this configuration, the beamsplitter will reflect some of the diverging light rays from the light field display 1105 toward the retroreflector, which reflects each of the light rays in the opposite direction, and causes them to converge to form holographic objects on the viewer side of the beamsplitter. An example of a retroreflector is a corner cube retroreflector array, which may be made of microstructures.

The light field display 1105 projects an out-of-screen holographic object 1115 on a viewer side 1120 of a screen plane 1125, and an in-screen holographic object 1130 on a display side 1135 of the screen plane 1125. Projected light rays 1140 that converge on a surface of holographic object 1115, and projected light rays 1145 that converge at in-screen holographic object 1130 (see the virtual light rays 1150), all diverge as they approach the transmissive reflector 1110. Incident light rays 1140 pass through the transmissive reflector 1110, undergoing reflections, and exit as light rays 1155, which converge to form a relayed holographic object 1160. Similarly, incident light rays 1145 are reflected within the transmissive reflector 1110 and emerge as converging light rays 1165, forming relayed holographic object 1170.

The effect is that a holographic object volume centered around the screen plane 1125 has now been relayed to be centered at virtual display surface 1175.

Notice that the holographic object 1130, which was further from a viewer 1180 than the holographic object 1115, is now closer to the viewer after the holographic object volume has been relayed. A vertical distance (D1) between the holographic object 1115 and the transmissive reflector 1110 is the same as a horizontal distance D1 between the relayed holographic object 1160 and the transmissive reflector 1110. Similarly, a vertical distance D2 between the holographic object 1130 and the transmissive reflector 1110 is the same as a horizontal distance between the relayed holographic object 1170 and the transmissive reflector 1110. The viewer 1180 sees the holographic object 1170 floating in space slightly in front of the holographic object 1160. However, angular light field coordinates U-V are reversed for holographic objects transmitted through the transmissive reflector 1110 and observed at by the viewer 1180. The result is that the depth appears to be reversed for some images and scenes. To correct for this, in one embodiment, light field rays projected by the light field display 1105 have their U-V polarities reversed by correction optics. In another embodiment, the light field rendering contains a step which reverses the polarity of the U-V coordinates before being displayed by the light field display 1105. This technique of relaying a holographic object volume may be used in vehicles to bring a holographic object volume closer to its occupants. The holographic object volume relay may be combined with other techniques, such as the use of one or more mirrors to create a folded optical system where optical path lengths required by the relay are achieved in a limited physical space.

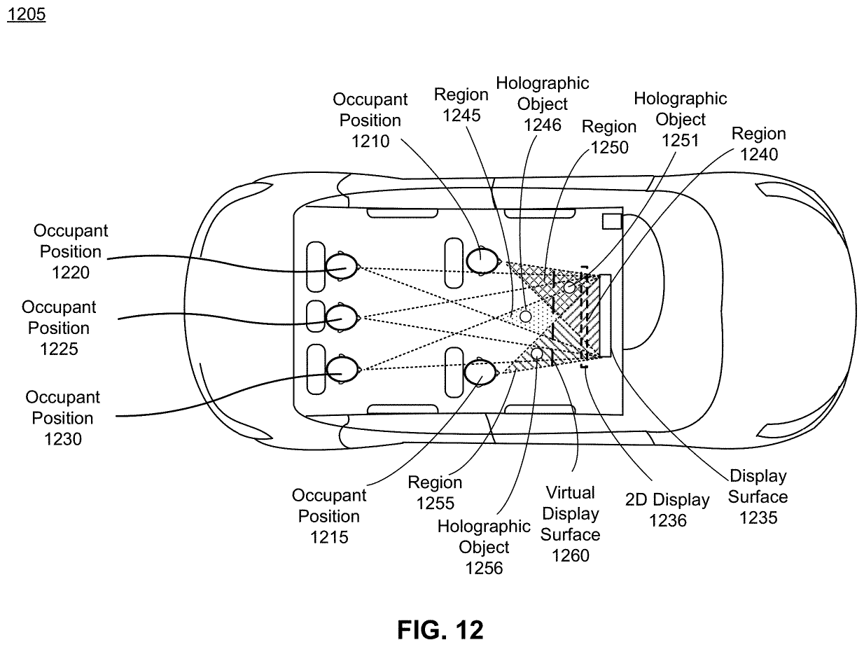

FIG. 12 illustrates overlap of occupant fields of view within a vehicle 1205, in accordance with one or more embodiments. The LF display system is an embodiment of the LF display system 500. In some embodiments, the LF display system of FIG. 12 uses the configuration system 1100 of FIG. 11 to relay holographic objects such that they appear closer to one or more occupants of the vehicle. In other embodiments, no holographic object volume relay is used.

The vehicle 1205 includes occupant positions 1210, 1215, 1220, 1225, and 1230. The occupant positions 1210, 1215, 1220, 1225, and 1230 are positions within the vehicle 1205 that an occupant generally occupies. For example, the occupant position 1210 corresponds to a position of an occupant sitting in a driver seat of the vehicle 1205, the occupant position 1215 corresponds to a position of an occupant sitting in a front passenger seat of the vehicle 1205, and the occupant positions 1220, 1225, 1230 correspond to different position of occupants sitting in back seats of the vehicle 1205. In some embodiments, the occupant positions 1210, 1215, 1220, 1225, and 1230 are fixed. In other embodiments, the LF display system may track actual physical positions of one or more of occupants. The LF display system may dynamically update respective occupant positions of the or more occupants to match the tracked physical positions of the occupants.

In the illustrated embodiment, the occupant positions 1210 and 1215 are closer to a display surface 1235 of the LF display system. Each occupant position 1210, 1215, 1220, 1225, and 1230 has its own field of view relative to the display screen 1235. In FIG. 12, each field of view is denoted with dashed lines and includes a respective holographic object volume and a respective viewing volume. The fields of view overlap within the vehicle 1205 to form regions 1240, regions 1245, region 1250, and region 1255. The region 1240 is a volume where the fields of view of each of the occupant positions 1210, 1215, 1220, 1225, and 1230 overlap such that a holographic object presented within the region 1240 is visible from each of the occupant positions 1210, 1215, 1220, 1225, and 1230. The region 1245 is a volume where the fields of view of the occupant positions 1220, 1225, and 1230 overlap such that a holographic object 1246 presented within the region 1245 is visible from the occupant positions 1220, 1225, and 1230, but is not visible from the occupant positions 1210 and 1215. The region 1250 is a volume where a holographic object 1251 presented within the region 1250 is visible from the occupant position 1210, but is not visible from the occupant positions 1215, 1220, 1225, and 1230. The region 1255 is a volume where a holographic object 1256 presented within the region 1255 is visible from the occupant position 1215, but is not visible from the occupant positions 1210, 1220, 1225, and 1230.

The vehicle 1205 may also include a 2D display 1236. The 2D display 1236 is optional. The 2D display 1236 is at least partially transparent to visible light. The 2D display 1236 may be, e.g., a OLED, LCD, some other display that is at least partially transparent, or some combination thereof. The 2D display 1236 may be placed in front of the light field display surface 1235, directly in the optical path of projected rays from the display surface 1235. The 2D display 1236 may be kept off while the light field display is operational and projecting holographic objects directly through its transparent surface, which will remain almost invisible. When the light field display system 500 is turned off, this 2D display 1236 may be used for a variety of purposes, including vehicle configuration and control, security access, emergency use, etc.

The LF display system may be configured such that a respective viewing volume is associated with at least a portion of one or more of the occupant positions 1210, 1215, 1220, 1225, and 1230. In this manner, the LF display system can selectively present holographic objects to one or more of occupants of the vehicle 1205. For example, the LF display may present one or more holographic objects in the region 1240 such that the one or more holographic objects are visible from all of the occupant positions 1210, 1215, 1220, 1225, and 1230. Similarly, the LF display system may present one or more holographic objects 1246 in the region 1245 such that the one or more holographic objects are visible from the occupant positions 1220, 1225, and 1230, but not the from the occupant positions 1210 and 1220. And in another example, the LF display system may present one or more holographic objects (e.g., a holographic object 1251) in the region 1250 such that the one or more holographic objects are visible from the occupant position 1210, but not from the other occupant positions of the vehicle 1205. Likewise, the LF display system may present one or more holographic objects (e.g., a holographic object 1256) in the region 1255 such that the one or more holographic objects are visible from the occupant position 1215, but not from the other occupant positions of the vehicle 1205.

In some embodiments, the LF display system may also generate a virtual display surface 1260 using the transmissive reflector 1110 shown in FIG. 11. The transmissive reflector is not shown in FIG. 11, but it may be placed above the display surface 1235, and function to relay the holographic object volume so that it is offset from the display surface, and centered on the virtual display surface 1260. The virtual display surface 1260 is similar to the virtual display surface 1175 described above with regard to FIG. 11. In this configuration, with a virtual display surface 1260 between the display and the vehicle occupants, holographic objects appear closer to one or more occupant positions of the vehicle 1205. In the illustrated embodiments, the virtual display surface 1260 could be presented in one or more of regions 1224, 1250, and 1255, but the virtual display surface 1260 is not presented in region 1240 (and likewise is not part of the holographic viewing volume that is behind the display surface 1235).

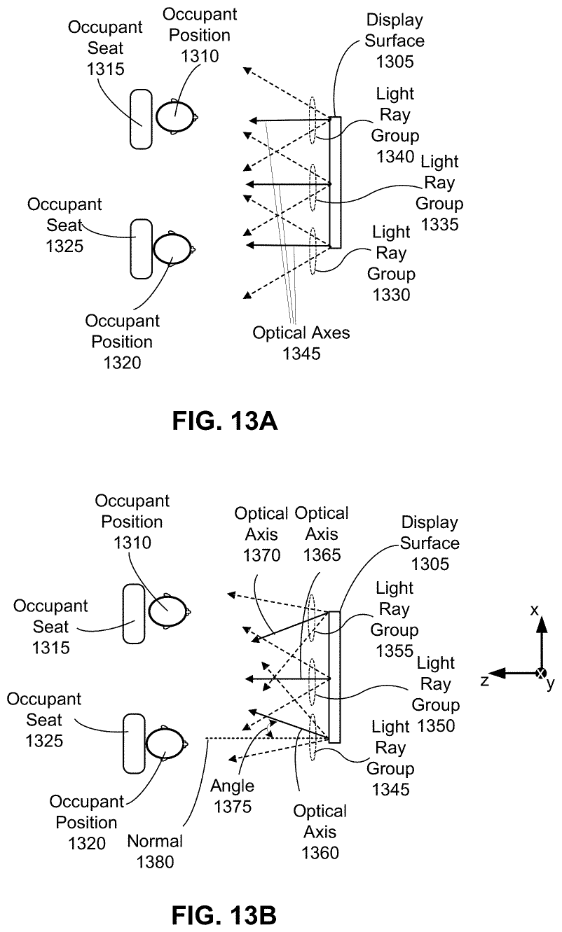

It may be advantageous to adjust the rays of light that are projected from the display surface in order to achieve a higher field of view for the vehicle occupants. FIG. 13A shows an example view of a light field display with a substantially uniform projection direction, in accordance with one or more embodiments. A display surface 1305 includes a plurality of surface locations, and each of the surface locations emits many separate light projection paths (or light rays) grouped substantially in a solid angle around a center light projection path, which we refer to as the optical axis for this display surface location. Each light ray group is centered on such an optical axis, which defines the direction of propagation for bundle of rays leaving the display surface at a given location on that display surface. The optical axis is a line of symmetry, since it may be coincident with the approximate midpoint of the angular range of light rays projected from the display surface in both the horizontal and vertical dimensions, and thus it may define the direction of propagation of the center light ray. Accordingly, the optical axis for a position on the display surface is often substantially aligned with the average energy vector for all the light rays leaving the display surface at that position. A substantially uniform projection direction occurs if the optical axes of all groups of rays projected from a display surface 1305 are parallel.

In the illustrated embodiment, each optical axis is parallel to a normal of the display surface 1305. In other embodiments, each optical axis may be at a respective angle to the normal (e.g., such that they are all canted in a particular direction). And as discussed below with regard to FIG. 13B, in some embodiments, the optical axes of different light groups may be at different angles to the normal of the display surface 1305. The display surface 1305 is located between an occupant position 1310 in an occupant seat 1315, and an occupant position 1320 in an occupant seat 1325. The display surface 1305 may be a virtual display surface similar to 1260 in FIG. 12. The display surface 1305 emits a plurality of light ray groups, e.g., a light ray group 1330, a light ray group 1335, and a light ray group 1340. The light ray groups 1330, 1335, and 1340 are projected by the display surface 1305 at three different locations on the display surface, and each of the light ray groups 1330, 1335, and 1340 have an optical axis—which are collectively referred to as optical axes 1345.

In the illustrated embodiment, all the optical axes 1345 are substantially normal to the display surface 1305 for every position on that display surface 1305. Note that no light rays from the group of light rays 1330 reach occupant position 1310, while no light rays from the group of light rays 1340 reach the occupant position 1320. This means that neither occupant position is in a viewing volume of the display surface 1305 (i.e., an occupant would not be able to see the vertical edge of the display furthest from them). This can be corrected by introducing a deflection to the group of light rays that are projected from each location on the display surface 1305. This deflection in the optical axis may be applied with different magnitude and direction at different points on the display surface to optimize the viewing volume for a given seating arrangement of viewers of the display, or in this case, vehicle occupants.

FIG. 13B shows an example view of a light field display with a variable projection direction, in accordance with one or more embodiments. In FIG. 13B, each group of projected light rays at each location on the display surface are deflected so that the optical axis is not always normal to the display surface 1305. The display surface 1305 emits a plurality of light ray groups, e.g., a light ray group 1345, a light ray group 1350, and a light ray group 1355. The light ray groups 1345, 1350, and 1355 are projected by the display surface 1305 at three different locations on the display surface, and the light ray groups 1345, 1350, and 1355 have the optical axes 1360, 1365, and 1370, respectively.

The groups of light rays 1345 and 1355 coming from the vertical edges of the display, and defined by center light rays at the optical axes 1360 and 1370, respectively, are projected toward the center of the display in a horizontal direction, such that the optical axes 1360 and 1365 have a substantial deflection angle relative to a normal to the display surface. Accordingly, the plurality of surface locations includes a first subset of the surface locations with an optical axis that is tilted at a first angle relative to the normal to the display surface. For example, the optical axis 1360 makes a non-zero angle 1375 with a normal 1380 to the display surface 1305 (i.e., a surface location associated with the light ray group 1345 is such that the optical axis 1360 is tilted at the angle 1375 with respect to the normal 1380). In contrast, the optical axis 1365 of the group of light rays 1350 is substantially parallel to the normal 1380. Note that in this configuration of FIG. 13B, some light rays from light ray group 1345 reach the occupant position 1310, and some of the light rays from the light ray group 1355 reach the occupant position 1320. As a result, occupants of the occupant positions 1310 and 1320 are now in a viewing volume of the display surface 1305, and can see the entire display surface 1305, in contrast to the case of FIG. 13A, where there is no deflection angle of the optical axis from a normal to the display surface 1305. The deflection angles shown in FIG. 13B are horizontal deflection angles that may vary gradually from a value of zero at a center of the display, to a substantially non-zero value as one moves horizontally across the display to one of the edges of the display. In other embodiments, only one or several discrete deflection angles may be used across a display surface. Different configurations of deflection angles may be used to optimize a light field display for a desired viewing volume geometry. Moreover, while the illustrated embodiment shows changes in deflection as a function of emission location along a horizontal axis (i.e., parallel to the x axis). In some embodiments, deflection angle may also change as a function of emission location along a vertical axis (i.e., parallel to the y axis). For example, as an emission location of a light ray group moves vertically, its corresponding deflection angle may change to help direct light from the emission location toward the occupant position 1310.

In one embodiment, the deflection angle may be achieved with the detailed construction of waveguides that project energy from an electromagnetic energy surface into propagation paths. In other embodiments, an optics layer placed over the light field display surface causes projected light rays to be deflected once they leave the light field display surface. In various embodiments, the optics layer may include a layer of refractive optics including prisms with varying properties, layers of glass with varying indices of refraction, or with mirrored layers, thin films, diffraction gratings, or the like. The layer of optics may be optimized for a particular expected audience geometry, allowing viewing volume customization with relatively low expense.

### Additional Configuration Information

The foregoing description of the embodiments of the disclosure has been presented for the purpose of illustration; it is not intended to be exhaustive or to limit the disclosure to the precise forms disclosed. Persons skilled in the relevant art can appreciate that many modifications and variations are possible in light of the above disclosure.

Some portions of this description describe the embodiments of the disclosure in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the disclosure may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the disclosure may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based hereon. Accordingly, the disclosure of the embodiments is intended to be illustrative, but not limiting, of the scope of the disclosure, which is set forth in the following claims.

1. A light field (LF) display system comprising:
a LF display assembly that includes at least one LF display module mounted on an internal surface of an interior of a vehicle, and the at least one LF display module is configured to present one or more holographic objects at a plurality of locations relative to a display surface of the at least one LF display module, wherein the locations include locations between the display surface and a viewing volume of the at least one display surface, and holographic objects presented between the display surface and the viewing volume are presented as real images, wherein a real image of a holographic object is formed from a plurality of light rays emitted from the at least one LF display module that converge at a location of a surface of the holographic object such that they appear to leave the surface from a perspective of a viewer, and different perspectives of the surface are visible from different locations within the viewing volume.

2. The LF display system of 1, wherein a holographic object of the one or more holographic objects is selected from a group consisting of: a two-dimensional object, a three-dimensional object, a control button, a control switch, a control dial, a steering control interface, instrument cluster, a music control interface, an entertainment video control interface, climate control interface, windows control interfaces, door control interfaces, a mapping control interface, a computer interface, a shifter, some other control interface for the vehicle, or some combination thereof.

3. The LF display system of claim 1, wherein:
a holographic object of the one or more holographic objects is selected from a group consisting of: a navigation screen which shows information about the vehicle's location, navigation aids, navigation directional indicators, navigational information, suggested vehicle routes, images associated with the vehicle surroundings, navigational content projected in front of the driver to help the driver keep focus on the road, navigational or informational content overlaid onto actual objects in the vicinity of the vehicle, or some combination thereof

4. The LF display system of claim 1, wherein the display surface includes a plurality of surface locations, and each surface location is configured to project a portion of holographic content along an optical axis defining an axis of symmetry for light leaving the display surface at that location, the plurality of surface locations comprising a first subset of the surface locations with an optical axis that is tilted at a first angle relative to the normal to the display surface.

5. The LF display system of claim 4, wherein a second subset of the plurality of surface locations projects a different portion of the holographic content along an optical axis that is tilted at a second angle relative to the normal to the display surface.

6. The LF display system of claim 1, further comprising:
a two-dimensional (2D) display that is at least partially transparent, the 2D display placed between the display surface and the viewing volume such that light from the display surface passes through the 2D display, and at least some of the light forms the one or more holographic objects.

7. The LF display system of claim of 1, wherein at least one of the one or more holographic objects changes dynamically responsive to an instruction from a controller.

8. The LF display system of claim of 7, wherein the instruction is generated by the controller responsive to an event selected from a group comprising: a user input, a change in vehicle status, a navigation reminder, a cell phone call, some other event that may be pre-programmed, and some combination thereof

9. The LF display system of claim of 1, further comprising:
a tracking system configured to track movement of the user; and
wherein a controller is configured to:
determine that the tracked movement is a gesture interacting with the at least one holographic object, and
perform an action based on the gesture.

10. The LF display system of claim of 9, wherein the action comprises adjusting a holographic object, adjusting an operating state of the vehicle, adjusting a control interface of the vehicle, adjusting an interior configuration of the vehicle, adjusting an arrangement of the one or more holographic objects, transferring data on a network, executing a phone call, performing a navigational update, or some combination thereof

11. The LF display system of claim of 9, wherein the tracking system is part of the at least one LF display module, and the at least one LF display module has a bidirectional LF display surface which simultaneously projects holographic objects and senses light from a local area adjacent to the display surface.

12. The LF display system of claim of 11, wherein the sensed light is a light field.

13. The LF display system of claim 1, further comprising a controller configured to:
in response to a user input, change one of: an operating state of the vehicle, a control interface of the vehicle, an interior configuration of the vehicle, at least one of the one or more holographic objects, an arrangement of the one or more holographic objects, or some combination thereof

14. The LF display system of claim 1, wherein the LF display assembly is further configured to generate a tactile surface in a local area of the display.

15. The LF display system of claim 14, wherein the tactile surface is coincident with a surface of at least one of the one or more holographic objects.

16. The LF display system of claim of 14, further comprising:
a tracking system configured to track movement of the user; and
wherein a controller is configured to:
determine that the tracked movement is a gesture associated with the tactile surface, and
perform an action based on the gesture.

17. The LF display system of claim of 16, wherein the action comprises adjusting a holographic object, adjusting the tactile surface, adjusting an operating state of the vehicle, adjusting a control interface of the vehicle, adjusting an interior configuration of the vehicle, adjusting an arrangement of the one or more holographic objects, transferring data on a network, executing a phone call, performing a navigational update, a preprogrammed event, or some combination thereof.

18. The LF display system of claim 14, wherein the at least one LF display module includes a dual-energy surface and projects both light as well as ultrasonic waves.

19. The LF display system of claim 1, wherein the display surface is a portion of a roof within the interior of the vehicle, and the one or more holographic objects emulates a sunroof and includes at least one holographic object presented within a holographic object volume of the display surface.

20. The LF display system of claim 1, wherein the display surface is a portion of an exterior wall of the vehicle, and the one or more holographic objects emulates a windowed view and includes at least one holographic object presented within a holographic object volume of the display surface.

21. The LF display system of claim 20, further comprising:
one or more cameras configured to capture images of a local area outside the vehicle, and wherein the at least one LF display module is configured to update the one or more holographic objects based in part on the captured images so that the exterior wall of the vehicle appears to be a transparent window.

22. The LF display system of claim 1, further comprising:
one or more cameras configured to capture images of a local area outside the vehicle, and
wherein the LF display assembly is configured to update the one or more holographic objects based in part on the captured images

23. The LF display system of claim 1, further comprising:
one or more cameras configured to capture images of a local area surrounding the vehicle, the local area at least partially not visible from inside the vehicle;
wherein the LF display assembly is configured to determine a rendering perspective for holographic content including the one or more holographic objects as a representation of the local area that is rendered as if the vehicle is transparent.

24. The LF display system of claim 1, further comprising:
one or more cameras configured to capture images of a local area surrounding the vehicle;
a tracking system configured to track an eye location of a user within the interior of the vehicle;
wherein the at least one LF display module is configured to determine a rendering perspective for holographic content including the one or more holographic objects based on the determined eye location relative to a location within the local area, and the holographic content is a representation of the local area that is rendered as if the vehicle is transparent.

25. The LF display system of claim 1, further comprising:
a tracking system configured to track a location of a user within the interior of the vehicle;
wherein the one or more holographic objects includes first holographic object for the user and second holographic object for a second user that is also within the interior of the vehicle, and the first holographic object is directed towards a first position associated with the user and is not directed to a second position associated with the second user.

26. The LF display system of claim 25, wherein the first holographic object is different from the second holographic object.

27. The LF display system of claim 1, comprising:
a plurality of LF display modules, including the at least one LF display module, each with a module display surface area, that are tiled together to form a seamless display surface that has a combined area that is larger than the module display surface area.

28. The LF display system of claim 1, wherein the holographic object volume of the at least one LF display module is relayed from the display surface to an offset position around a virtual display surface which is closer to the occupants of the vehicle than the display surface.

29. The LF display system of claim 28, wherein the holographic object volume of the at least one LF display module is relayed using at least one of a dihedral corner reflector.

30. The LF display system of claim 28, wherein the holographic object volume of the at least one LF display module is relayed using a beamsplitter and a retroreflector.

31. The LF display system of claim 28, wherein the vehicle includes a first occupant position and a second occupant position and the virtual display surface presents a holographic object that is visible from the first occupant position and is not visible from the second occupant position.

32. The LF display system of claim 1, wherein the one or more holographic objects includes a first holographic object, and the first holographic object is directed towards a first viewing volume associated with a first position within the vehicle, and does not include a second viewing volume that is associated with a second position within the vehicle.

33. The LF display system of claim 1, wherein the one or more holographic objects includes a first holographic object, and the first holographic object is directed towards a first viewing volume associated with a first position within the vehicle, and a portion of the first viewing volume overlaps with a second viewing volume that is associated with a second position within the vehicle.

34. The (LF) display system of claim 1, wherein the one or more holographic objects includes a holographic driver.

35. The LF display system of claim 1, wherein the light field display assembly is further configured to have one or more energy surfaces, each energy surface containing a plurality of light source locations, and further comprising:
a plurality of waveguides, wherein each waveguide of the array of waveguides is configured to receive light from a corresponding subset of the plurality of light source locations, and each waveguide directs light along a plurality of propagation paths, each propagation path of the plurality of propagation paths corresponding to a light source location, and the direction of each propagation path determined at least by the location of the corresponding light source location relative to the waveguide.

36. A LF display system comprising:
at least one LF display module mounted on an exterior surface of a vehicle, and the at least one LF display module projects holographic objects at a plurality of configurable physical locations relative to a display surface of the at least one LF display module, wherein the locations include locations between the display surface and a viewing volume of the at least one display surface, and
wherein the holographic objects change an external appearance of the vehicle.

37. The LF display system of claim 36, wherein the holographic objects act to camouflage the vehicle with its surroundings.

38. The LF display system of claim 36, wherein the exterior surface of the vehicle includes a first side on a portion of the vehicle and a second side on a second portion of the vehicle that is opposite to the first side, and the LF display system further comprises:
one or more cameras that are configured to capture images of a local area surrounding the vehicle; and
a controller module configured to:
determine a rendering perspective for a viewer within a viewing volume on the first side of the vehicle based on the captured images,
wherein at least some of the holographic objects form a representation of the portion of the local area that surrounds the second side of the vehicle such that at least a portion of the vehicle appears to be transparent.
